(19) United States
(12) Patent Application Publication
(10) Pub. No.: US 2025/0381474 A1
(43) Pub. Date: Dec. 18, 2025

(54) NON-TRANSITORY COMPUTER-READABLE STORAGE MEDIUM HAVING GAME PROGRAM STORED THEREIN, GAME SYSTEM, AND GAME PROCESSING METHOD

(71) Applicant: NINTENDO CO., LTD., Kyoto (JP)

(72) Inventor: Kohei KASAMA, Tokyo (JP)

(21) Appl. No.: 19/175,459

(22) Filed: Apr. 10, 2025

(30) Foreign Application Priority Data
Jun. 17, 2024 (JP) 2024-097442

(51) Int. Cl. A63F 13/285; A63F 13/52

(52) U.S. Cl. CPC A63F 13/285; A63F 13/52

(57) ABSTRACT

A computer of an information processing apparatus is caused to execute, in a virtual space, a multiplayer game in which a player character is controlled based on an operation input to an operation device, and an opponent character is controlled based on data acquired through communication with another information processing apparatus. In the multiplayer game, the computer is caused to specify a delay time of the communication, and when a first determination condition based on the operation input has been satisfied, is caused to output a signal for vibrating a vibration device included in the operation device, regardless of the delay time, and cause the player character to start a first action when a period according to a length of the delay time has elapsed.

### CROSS REFERENCE TO RELATED APPLICATION

This application claims priority to Japanese Patent Application No. 2024-097442, filed on Jun. 17, 2024, the entire contents of which are incorporated herein by reference.

### FIELD

The present disclosure relates to game processing in which an operation device itself is moved to play a game.

### BACKGROUND AND SUMMARY

Hitherto, a communication match game in which a player performs an action of swinging an operation device (hereinafter, controller) to cause a player character to perform a predetermined action, specifically, a punching action, has been known. In this game, a process of achieving synchronization between transmission and reception of result information of game processing, is performed. In this case, a measure to address communication delays is performed as follows. That is, in a reception-side terminal that has received punching action start information from a transmission-side terminal, after a punching action is started, a process of shortening the punching action is performed, and result information is returned to the transmission-side terminal.

There is room for improving bodily sensation of the user in the game in which the measure to address communication delays is performed.

In view of the above circumstances, for example, the following configuration examples are exemplified.

### Configuration 1

Configuration 1 is a non-transitory computer-readable storage medium having stored therein a game program causing a computer of an information processing apparatus to execute, in a virtual space, a multiplayer game in which a player character is controlled based on an operation input to an operation device, and an opponent character is controlled based on data acquired through communication with another information processing apparatus. In the multiplayer game, the computer is caused to specify a delay time of the communication. When a first determination condition based on the operation input has been satisfied, the computer is caused to output a signal for vibrating a vibration device included in the operation device, regardless of the delay time, and cause the player character to start a first action when a period according to a length of the delay time has elapsed.

According to the above configuration, even when start of an action of the player character is delayed as a measure to address a communication delay, a vibration that is a feedback to the user is outputted in advance without delaying the same. Therefore, an impression that a reaction of the player character is delayed can be weakened, thereby improving bodily sensation of the user.

### Configuration 2

According to configuration 2, in the above configuration 1, the operation device may include an inertial sensor. The operation input may include at least inertial data based on an output of the inertial sensor, and the first determination condition may be a condition related to the inertial data.

According to the above configuration, configuration 1 is applied to feedback in performing an intuitive/sensible input based on an output of the inertial sensor, thereby further improving the bodily sensation of the user.

### Configuration 3

According to configuration 3, in the above configuration 1, the computer may be further caused to output a sound associated with the first action, when the first action is started.

According to the above configuration, in the situation where the appearance of the action of the player character is made to coincide with the sound, the user is allowed to feel only a vibration in advance, thereby improving the bodily sensation related to an operation performed by the user.

### Configuration 4

According to configuration 4, in the above configuration 1, the computer may be further caused to output the signal for vibrating the vibration device, and output a sound associated with the first action.

According to the above configuration, the sound output is not delayed with respect to the vibration output, thereby improving the bodily sensation.

### Configuration 5

According to configuration 5, in any of the above configurations 1 to 4, the multiplayer game may be a ball sport game. The first action may be an action of shooting a ball toward a goal.

According to the above configuration, the user is allowed to feel a vibration as a feedback according to the action of shooting the ball, without a delay in operation. Therefore, even if the shooting action by the player character is delayed, the user is unlikely to feel the delay as bodily sensation, thereby improving the bodily sensation of the user.

### Configuration 6

According to configuration 6, in the above configuration 5, the computer may be further caused to make the player character perform a block action of blocking a shot attempted by the opponent character, when a second determination condition based on the operation input has been satisfied.

In a communication match game in which shooting and blocking are performed, it is highly necessary to delay an action of shooting according to a communication delay. According to the above configuration, even in such a situation, it is possible to maintain the bodily sensation of the user regarding an operation of shooting, by outputting a vibration in advance.

The above-described configurations may be applied to a game system, a game apparatus, and a game processing method.

According to the exemplary embodiment, it is possible to improve the bodily sensation of the user in ball sport games in which a measure to address communication delays is performed.

### BRIEF DESCRIPTION OF THE DRAWINGS

FIG. 1 is a schematic diagram showing a non-limiting example of the entire configuration of an information processing system according to an exemplary embodiment;

FIG. 2 is a block diagram showing a non-limiting example of the hardware configuration of a server 1000;

FIG. 3 shows a non-limiting example of a state where a left controller 3 and a right controller 4 are attached to a main body apparatus 2;

FIG. 4 shows a non-limiting example of a state where the left controller 3 and the right controller 4 are detached from the main body apparatus 2;

FIG. 5 is six orthogonal views showing a non-limiting example of the main body apparatus 2;

FIG. 6 is six orthogonal views showing a non-limiting example of the left controller 3;

FIG. 7 is six orthogonal views showing a non-limiting example of the right controller 4;

FIG. 8 is a block diagram showing a non-limiting example of the internal configuration of the main body apparatus 2;

FIG. 9 is a block diagram showing non-limiting examples of the internal configurations of the main body apparatus 2, the left controller 3, and the right controller 4;

FIG. 10 shows a non-limiting example of a game screen according to the exemplary embodiment;

FIG. 11 shows a non-limiting example of a posture of a user (controller) when playing a game;

FIG. 12 illustrates a flow of a game according to the exemplary embodiment;

FIG. 13 shows a non-limiting example of a vertical swing operation;

FIG. 14 shows a non-limiting example of a game screen according to the exemplary embodiment;

FIG. 15 shows a non-limiting example of a shooting mode shifting operation;

FIG. 16 shows a non-limiting example of a game screen according to the exemplary embodiment;

FIG. 17 shows a non-limiting example of a swing up operation;

FIG. 18 shows a non-limiting example of a game screen according to the exemplary embodiment;

FIG. 19 shows a non-limiting example of a shooting operation;

FIG. 20 shows a non-limiting example of a game screen according to the exemplary embodiment;

FIG. 21 illustrates a flow of processing after the shooting operation;

FIG. 22 schematically illustrates vibration output timing according to the exemplary embodiment;

FIG. 23 is a memory map showing a non-limiting example of various kinds of data stored in a DRAM 85;

FIG. 24 is a flowchart showing the details of game processing according to the exemplary embodiment;

FIG. 25 is a flowchart showing the details of a stop state process;

FIG. 26 is a flowchart showing the details of a moving state process;

FIG. 27 is a flowchart showing the details of a shooting mode process;

FIG. 28 is a flowchart showing the details of a shooting preparation process;

FIG. 29 is a flowchart showing the details of a mid-jump process;

FIG. 30 is a flowchart showing the details of a shooting process; and

FIG. 31 is a flowchart showing the details of the shooting process.

### DETAILED DESCRIPTION OF NON-LIMITING EXAMPLE EMBODIMENTS

Hereinafter, one exemplary embodiment will be described. FIG. 1 is a schematic diagram showing the entire configuration of an information processing system according to the exemplary embodiment. The information processing system of the exemplary embodiment includes a plurality of game systems 1 and a server 1000. The server 1000 and each game system 1 are configured to be able to communicate with each other via a network such as the Internet. In the exemplary embodiment, with this configuration, ball sport game processing in which the game systems 1 perform a communication match while communicating with the server 10 according to need will be described as an example.

### Hardware Configuration of Server

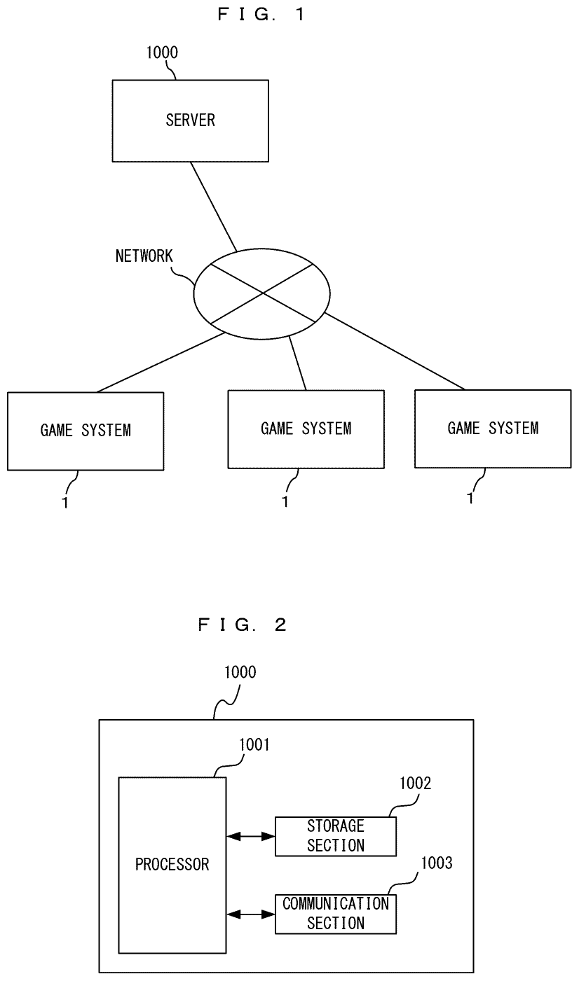

Next, the hardware configuration of the server 1000 will be described. FIG. 2 is a block diagram showing the hardware configuration of the server 1000. The server 1000 includes at least a processor 1001, a storage section 1002, and a communication section 1003. The processor 1001 executes various programs for controlling the server 1000. In the storage section 1002, various programs to be executed by the processor 1001 and various kinds of data to be used by the processor 1001 are stored. The communication section 1003 connects to the network by means of wired or wireless communication and transmits/receives predetermined data to/from the game system 1. In the exemplary embodiment, an example in which there is one server 1000 is illustrated, but the server 1000 may be a single server or may be configured as a group of servers that perform distributed processing.

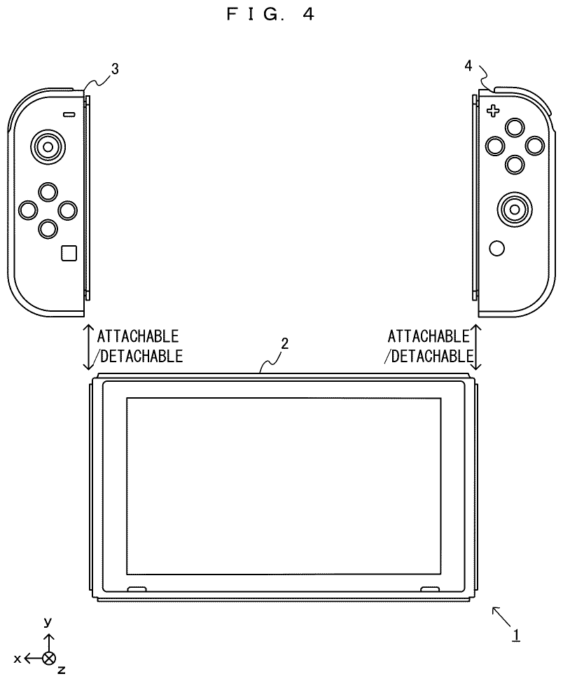

Next, the above game system 1 will be described. An example of the game system 1 according to the exemplary embodiment includes a main body apparatus (information processing apparatus which functions as a game apparatus body in the exemplary embodiment) 2, a left controller 3, and a right controller 4. Each of the left controller 3 and the right controller 4 is attachable to and detachable from the main body apparatus 2. That is, the game system 1 can be used as a unified apparatus obtained by attaching each of the left controller 3 and the right controller 4 to the main body apparatus 2. Moreover, in the game system 1, the main body apparatus 2, the left controller 3, and the right controller 4 can also be used as separate bodies (see FIG. 4). Hereinafter, first, the hardware configuration of the game system 1 of the exemplary embodiment is described, and then, the control of the game system 1 of the exemplary embodiment is described.

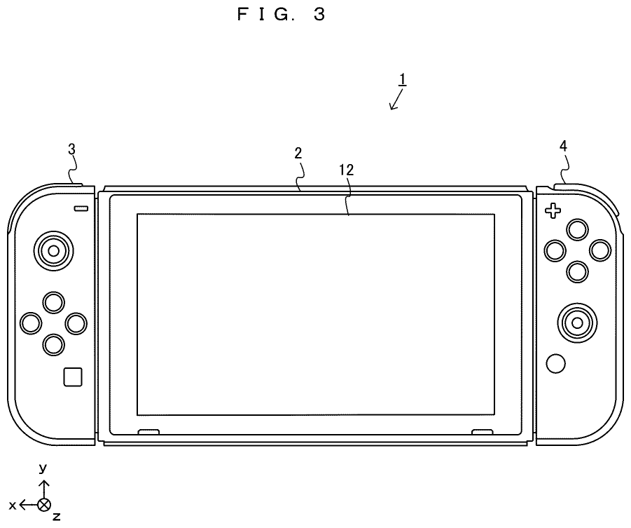

FIG. 3 shows an example of the state where the left controller 3 and the right controller 4 are attached to the main body apparatus 2. As shown in FIG. 3, each of the left controller 3 and the right controller 4 is attached to and unified with the main body apparatus 2. The main body apparatus 2 is an apparatus for performing various kinds of processing (e.g., game processing) in the game system 1. The main body apparatus 2 includes a display 12. Each of the left controller 3 and the right controller 4 is an apparatus including operation sections with which a player provides inputs.

FIG. 4 shows an example of the state where each of the left controller 3 and the right controller 4 is detached from the main body apparatus 2. As shown in FIGS. 1 and 2, the left controller 3 and the right controller 4 are attachable to and detachable from the main body apparatus 2. Hereinafter, the left controller 3 and the right controller 4 may be collectively referred to as “controller”.

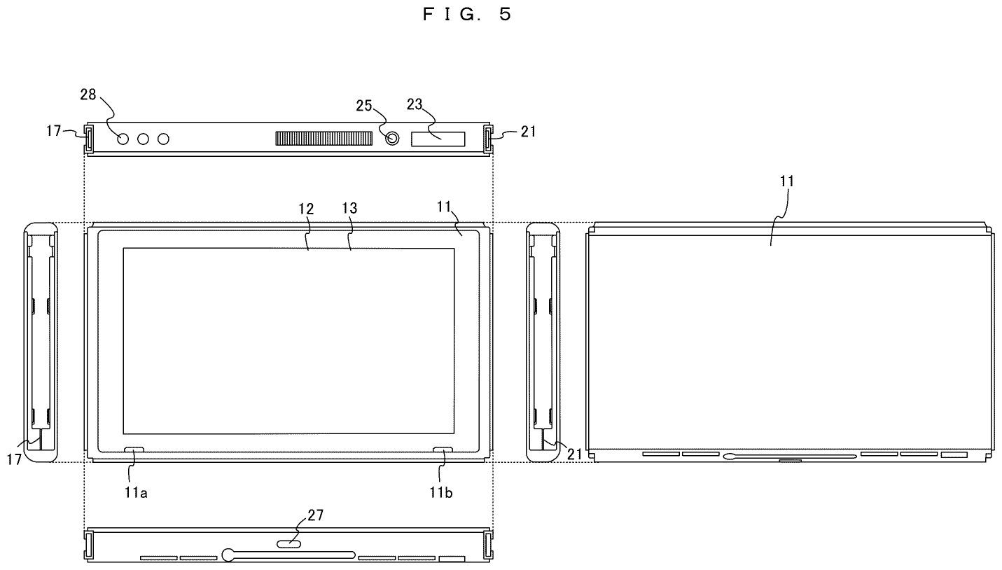

FIG. 5 is six orthogonal views showing an example of the main body apparatus 2. As shown in FIG. 5, the main body apparatus 2 includes an approximately plate-shaped housing 11. In the exemplary embodiment, a main surface (in other words, a surface on a front side, i.e., a surface on which the display 12 is provided) of the housing 11 has a substantially rectangular shape.

The shape and the size of the housing 11 are discretionary. As an example, the housing 11 may be of a portable size. Further, the main body apparatus 2 alone or the unified apparatus obtained by attaching the left controller 3 and the right controller 4 to the main body apparatus 2 may function as a mobile apparatus. The main body apparatus 2 or the unified apparatus may function as a handheld apparatus or a portable apparatus.

As shown in FIG. 5, the main body apparatus 2 includes the display 12, which is provided on the main surface of the housing 11. The display 12 displays an image generated by the main body apparatus 2. In the exemplary embodiment, the display 12 is a liquid crystal display device (LCD). The display 12, however, may be a display device of any type.

The main body apparatus 2 includes a touch panel 13 on the screen of the display 12. In the exemplary embodiment, the touch panel 13 is of a type capable of receiving a multi-touch input (e.g., electrical capacitance type). However, the touch panel 13 may be of any type, and may be, for example, of a type capable of receiving a single-touch input (e.g., resistive film type).

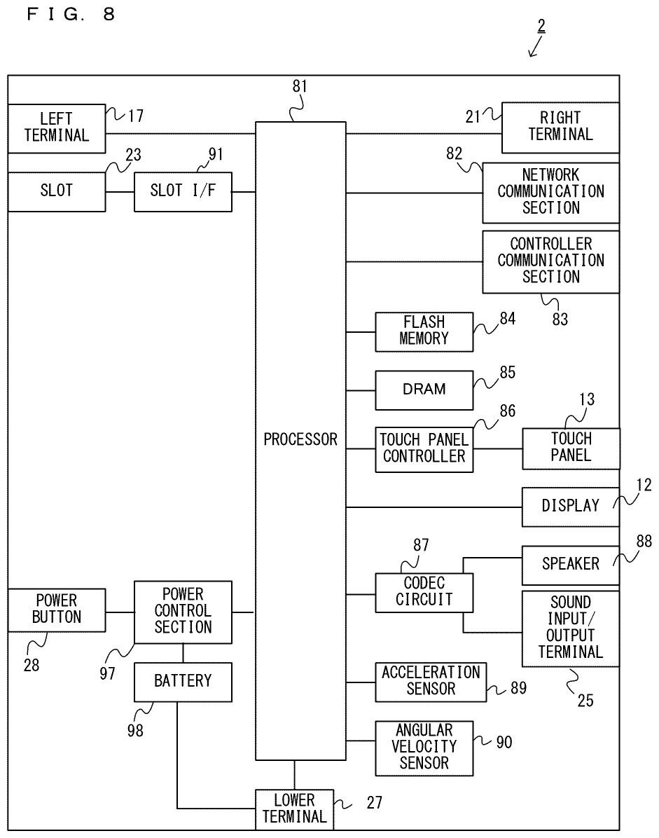

The main body apparatus 2 includes speakers (i.e., speakers 88 shown in FIG. 8) within the housing 11. As shown in FIG. 5, speaker holes 11a and 11b are formed in the main surface of the housing 11. Then, sounds outputted from the speakers 88 are outputted through the speaker holes 11a and 11b.

Further, the main body apparatus 2 includes a left terminal 17, which is a terminal for the main body apparatus 2 to perform wired communication with the left controller 3, and a right terminal 21, which is a terminal for the main body apparatus 2 to perform wired communication with the right controller 4.

As shown in FIG. 5, the main body apparatus 2 includes a slot 23. The slot 23 is provided at an upper side surface of the housing 11. The slot 23 is so shaped as to allow a predetermined type of storage medium to be attached to the slot 23. The predetermined type of storage medium is, for example, a dedicated storage medium (e.g., a dedicated memory card) for the game system 1 and an information processing apparatus of the same type as the game system 1. The predetermined type of storage medium is used to store, for example, data (e.g., saved data of an application or the like) used by the main body apparatus 2 and/or a program (e.g., a program for an application or the like) executed by the main body apparatus 2. Further, the main body apparatus 2 includes a power button 28.

The main body apparatus 2 includes a lower terminal 27. The lower terminal 27 is a terminal for the main body apparatus 2 to communicate with a cradle. In the exemplary embodiment, the lower terminal 27 is a USB connector (more specifically, a female connector). Further, when the unified apparatus or the main body apparatus 2 alone is mounted on the cradle, the game system 1 can display on a stationary monitor an image generated by and outputted from the main body apparatus 2. Further, in the exemplary embodiment, the cradle has the function of charging the unified apparatus or the main body apparatus 2 alone mounted on the cradle. Further, the cradle has the function of a hub device (specifically, a USB hub).

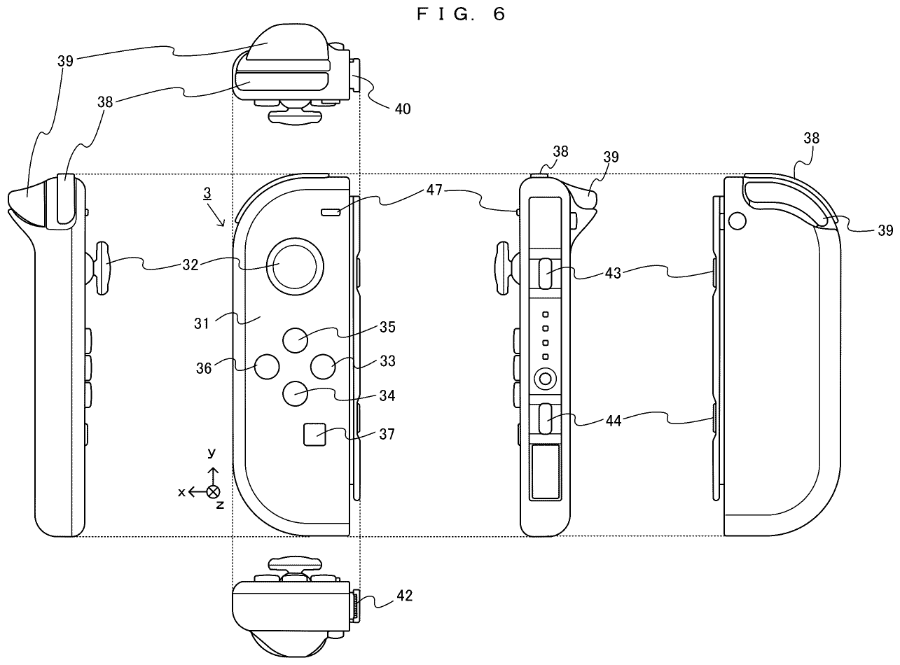

FIG. 6 is six orthogonal views showing an example of the left controller 3. As shown in FIG. 6, the left controller 3 includes a housing 31. In the exemplary embodiment, the housing 31 has a vertically long shape, i.e., is shaped to be long in an up-down direction shown in FIG. 6 (i.e., a y-axis direction shown in FIG. 6). In the state where the left controller 3 is detached from the main body apparatus 2, the left controller 3 can also be held in the orientation in which the left controller 3 is vertically long. The housing 31 has such a shape and a size that when held in the orientation in which the housing 31 is vertically long, the housing 31 can be held with one hand, particularly, the left hand. Further, the left controller 3 can also be held in the orientation in which the left controller 3 is horizontally long. When held in the orientation in which the left controller 3 is horizontally long, the left controller 3 may be held with both hands.

The left controller 3 includes a left analog stick (hereinafter, referred to as a “left stick”) 32 as an example of a direction input device. As shown in FIG. 6, the left stick 32 is provided on a main surface of the housing 31. The left stick 32 can be used as a direction input section with which a direction can be inputted. The player tilts the left stick 32 and thereby can input a direction corresponding to the direction of the tilt (and input a magnitude corresponding to the angle of the tilt). The left controller 3 may include a directional pad, a slide stick that allows a slide input, or the like as the direction input section, instead of the analog stick. Further, in the exemplary embodiment, it is possible to provide an input by pressing the left stick 32.

The left controller 3 includes various operation buttons. The left controller 3 includes four operation buttons 33 to 36 (specifically, a right direction button 33, a down direction button 34, an up direction button 35, and a left direction button 36) on the main surface of the housing 31. Further, the left controller 3 includes a record button 37 and a “−” (minus) button 47. The left controller 3 includes a first L-button 38 and a ZL-button 39 in an upper left portion of a side surface of the housing 31. Further, the left controller 3 includes a second L-button 43 and a second R-button 44, on the side surface of the housing 31 on which the left controller 3 is attached to the main body apparatus 2. These operation buttons are used to give instructions depending on various programs (e.g., an OS program and an application program) executed by the main body apparatus 2.

Further, the left controller 3 includes a terminal 42 for the left controller 3 to perform wired communication with the main body apparatus 2.

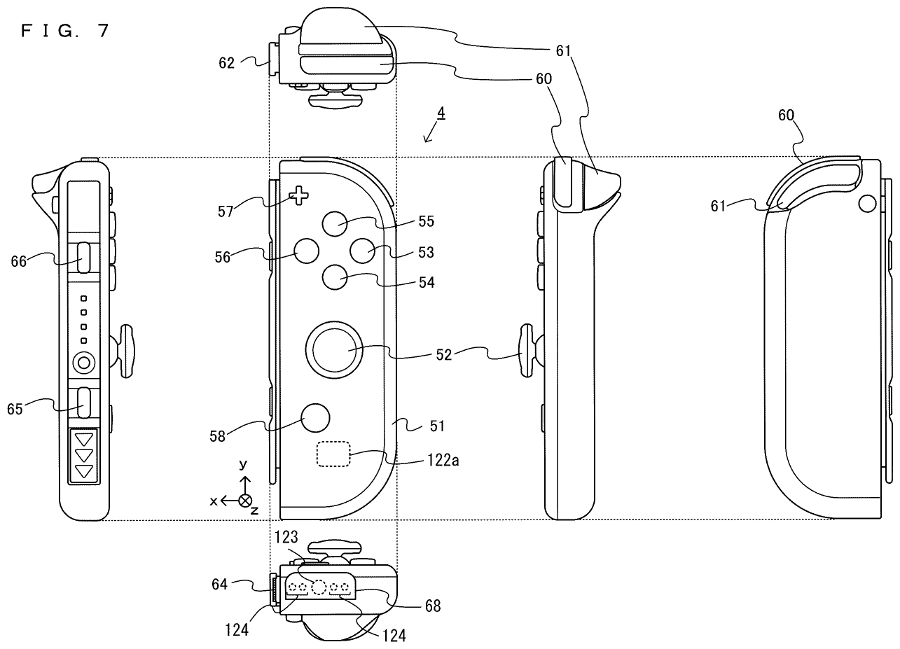

FIG. 7 is six orthogonal views showing an example of the right controller 4. As shown in FIG. 7, the right controller 4 includes a housing 51. In the exemplary embodiment, the housing 51 has a vertically long shape, i.e., is shaped to be long in the up-down direction shown in FIG. 7 (i.e., the y-axis direction shown in FIG. 7). In the state where the right controller 4 is detached from the main body apparatus 2, the right controller 4 can also be held in the orientation in which the right controller 4 is vertically long. The housing 51 has such a shape and a size that when held in the orientation in which the housing 51 is vertically long, the housing 51 can be held with one hand, particularly the right hand. Further, the right controller 4 can also be held in the orientation in which the right controller 4 is horizontally long. When held in the orientation in which the right controller 4 is horizontally long, the right controller 4 may be held with both hands.

Similarly to the left controller 3, the right controller 4 includes a right analog stick (hereinafter, referred to as a “right stick”) 52 as a direction input section. In the exemplary embodiment, the right stick 52 has the same configuration as that of the left stick 32 of the left controller 3. Further, the right controller 4 may include a directional pad, a slide stick that allows a slide input, or the like, instead of the analog stick. Further, similarly to the left controller 3, the right controller 4 includes four operation buttons 53 to 56 (specifically, an A-button 53, a B-button 54, an X-button 55, and a Y-button 56) on a main surface of the housing 51. Further, the right controller 4 includes a “+” (plus) button 57 and a home button 58. Further, the right controller 4 includes a first R-button 60 and a ZR-button 61 in an upper right portion of a side surface of the housing 51. Further, similarly to the left controller 3, the right controller 4 includes a second L-button 65 and a second R-button 66.

Further, the right controller 4 includes a terminal 64 for the right controller 4 to perform wired communication with the main body apparatus 2.

FIG. 8 is a block diagram showing an example of the internal configuration of the main body apparatus 2. The main body apparatus 2 includes components 81 to 91, 97, and 98 shown in FIG. 8 in addition to the components shown in FIG. 5. Some of the components 81 to 91, 97, and 98 may be mounted as electronic components on an electronic circuit board and housed in the housing 11.

The main body apparatus 2 includes a processor 81. The processor 81 is an information processing section for executing various types of information processing to be executed by the main body apparatus 2. For example, the processor 81 may be composed only of a CPU (Central Processing Unit), or may be composed of a SoC (System-on-a-chip) having a plurality of functions such as a CPU function and a GPU (Graphics Processing Unit) function. The processor 81 executes an information processing program (e.g., a game program) stored in a storage section (specifically, an internal storage medium such as a flash memory 84, an external storage medium attached to the slot 23, or the like), thereby performing the various types of information processing.

The main body apparatus 2 includes the flash memory 84 and a DRAM (Dynamic Random Access Memory) 85 as examples of internal storage media built into the main body apparatus 2. The flash memory 84 and the DRAM 85 are connected to the processor 81. The flash memory 84 is a memory mainly used to store various kinds of data (or programs) to be saved in the main body apparatus 2. The DRAM 85 is a memory used to temporarily store various kinds of data used for information processing.

The main body apparatus 2 includes a slot interface (hereinafter, abbreviated as “I/F”) 91. The slot I/F 91 is connected to the processor 81. The slot I/F 91 is connected to the slot 23, and in accordance with an instruction from the processor 81, reads and writes data from and to the predetermined type of storage medium (e.g., a dedicated memory card) attached to the slot 23.

The processor 81 appropriately reads and writes data from and to the flash memory 84, the DRAM 85, and each of the above storage media, thereby performing the above information processing.

The main body apparatus 2 includes a network communication section 82. The network communication section 82 is connected to the processor 81. The network communication section 82 communicates (specifically, through wireless communication) with an external apparatus via a network. In the exemplary embodiment, as a first communication form, the network communication section 82 connects to a wireless LAN and communicates with an external apparatus, using a method compliant with the Wi-Fi standard. Further, as a second communication form, the network communication section 82 wirelessly communicates with another main body apparatus 2 of the same type, using a predetermined method for communication (e.g., communication based on a unique protocol or infrared light communication). The wireless communication in the above second communication form achieves the function of enabling so-called “local communication” in which the main body apparatus 2 can wirelessly communicate with another main body apparatus 2 placed in a closed local network area, and the plurality of main body apparatuses 2 directly communicate with each other to transmit and receive data.

The main body apparatus 2 includes a controller communication section 83. The controller communication section 83 is connected to the processor 81. The controller communication section 83 wirelessly communicates with the left controller 3 and/or the right controller 4. The communication method between the main body apparatus 2, and the left controller 3 and the right controller 4, is discretionary. In the exemplary embodiment, the controller communication section 83 performs communication compliant with the Bluetooth (registered trademark) standard with the left controller 3 and with the right controller 4.

The processor 81 is connected to the left terminal 17, the right terminal 21, and the lower terminal 27. When performing wired communication with the left controller 3, the processor 81 transmits data to the left controller 3 via the left terminal 17 and also receives operation data from the left controller 3 via the left terminal 17. Further, when performing wired communication with the right controller 4, the processor 81 transmits data to the right controller 4 via the right terminal 21 and also receives operation data from the right controller 4 via the right terminal 21. Further, when communicating with the cradle, the processor 81 transmits data to the cradle via the lower terminal 27. As described above, in the exemplary embodiment, the main body apparatus 2 can perform both wired communication and wireless communication with each of the left controller 3 and the right controller 4. Further, when the unified apparatus obtained by attaching the left controller 3 and the right controller 4 to the main body apparatus 2 or the main body apparatus 2 alone is attached to the cradle, the main body apparatus 2 can output data (e.g., image data or sound data) to the stationary monitor or the like via the cradle.

Here, the main body apparatus 2 can communicate with a plurality of left controllers 3 simultaneously (in other words, in parallel). Further, the main body apparatus 2 can communicate with a plurality of right controllers 4 simultaneously (in other words, in parallel). Thus, a plurality of players can simultaneously provide inputs to the main body apparatus 2, each using a set of the left controller 3 and the right controller 4. As an example, a first player can provide an input to the main body apparatus 2 using a first set of the left controller 3 and the right controller 4, and simultaneously, a second player can provide an input to the main body apparatus 2 using a second set of the left controller 3 and the right controller 4.

The main body apparatus 2 includes a touch panel controller 86, which is a circuit for controlling the touch panel 13. The touch panel controller 86 is connected between the touch panel 13 and the processor 81. On the basis of a signal from the touch panel 13, the touch panel controller 86 generates data indicating the position at which a touch input has been performed, for example, and outputs the data to the processor 81.

Further, the display 12 is connected to the processor 81. The processor 81 displays a generated image (e.g., an image generated by executing the above information processing) and/or an externally acquired image on the display 12.

The main body apparatus 2 includes a codec circuit 87 and speakers (specifically, a left speaker and a right speaker) 88. The codec circuit 87 is connected to the speakers 88 and a sound input/output terminal 25 and also connected to the processor 81. The codec circuit 87 is a circuit for controlling the input and output of sound data to and from the speakers 88 and the sound input/output terminal 25.

The main body apparatus 2 includes a power control section 97 and a battery 98. The power control section 97 is connected to the battery 98 and the processor 81. Further, although not shown in FIG. 6, the power control section 97 is connected to components of the main body apparatus 2 (specifically, components that receive power supplied from the battery 98, the left terminal 17, and the right terminal 21). On the basis of a command from the processor 81, the power control section 97 controls the supply of power from the battery 98 to the above components.

Further, the battery 98 is connected to the lower terminal 27. When an external charging device (e.g., the cradle) is connected to the lower terminal 27 and power is supplied to the main body apparatus 2 via the lower terminal 27, the battery 98 is charged with the supplied power.

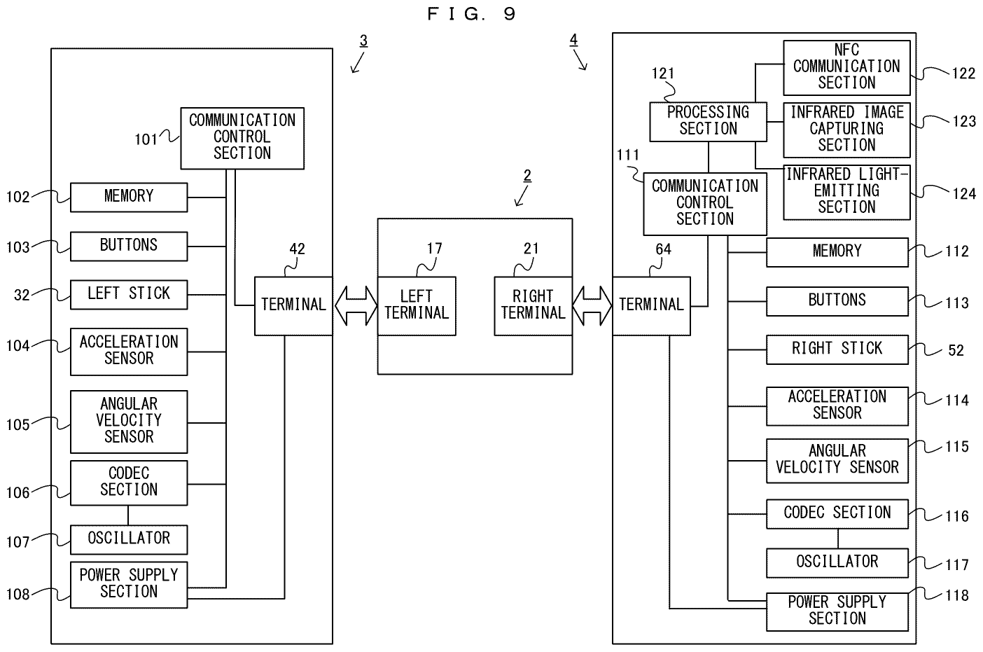

FIG. 9 is a block diagram showing examples of the internal configurations of the main body apparatus 2, the left controller 3, and the right controller 4. The details of the internal configuration of the main body apparatus 2 are shown in FIG. 8 and therefore are omitted in FIG.

9.

The left controller 3 includes a communication control section 101, which communicates with the main body apparatus 2. As shown in FIG. 9, the communication control section 101 is connected to components including the terminal 42. In the exemplary embodiment, the communication control section 101 can communicate with the main body apparatus 2 through both wired communication via the terminal 42 and wireless communication not via the terminal 42. The communication control section 101 controls the method for communication performed by the left controller 3 with the main body apparatus 2. That is, when the left controller 3 is attached to the main body apparatus 2, the communication control section 101 communicates with the main body apparatus 2 via the terminal 42. Further, when the left controller 3 is detached from the main body apparatus 2, the communication control section 101 wirelessly communicates with the main body apparatus 2 (specifically, the controller communication section 83). The wireless communication between the communication control section 101 and the controller communication section 83 is performed in accordance with the Bluetooth (registered trademark) standard, for example.

Further, the left controller 3 includes a memory 102 such as a flash memory. The communication control section 101 includes, for example, a microcomputer (or a microprocessor) and executes firmware stored in the memory 102, thereby performing various processes.

The left controller 3 includes buttons 103 (specifically, the buttons 33 to 39, 43, 44, and 47). Further, the left controller 3 includes the left stick 32. Each of the buttons 103 and the left stick 32 outputs information regarding an operation performed on itself to the communication control section 101 repeatedly at appropriate timings.

The left controller 3 includes inertial sensors. Specifically, the left controller 3 includes an acceleration sensor 104. Further, the left controller 3 includes an angular velocity sensor 105. In the exemplary embodiment, the acceleration sensor 104 detects the magnitudes of accelerations along predetermined three axial (e.g., x, y, z axes shown in FIG. 6) directions. The acceleration sensor 104 may detect an acceleration along one axial direction or accelerations along two axial directions. In the exemplary embodiment, the angular velocity sensor 105 detects angular velocities about predetermined three axes (e.g., the x, y, z axes shown in FIG. 6). The angular velocity sensor 105 may detect an angular velocity about one axis or angular velocities about two axes. Each of the acceleration sensor 104 and the angular velocity sensor 105 is connected to the communication control section 101. Then, the detection results of the acceleration sensor 104 and the angular velocity sensor 105 are outputted to the communication control section 101 repeatedly at appropriate timings.

The communication control section 101 acquires information regarding an input (specifically, information regarding an operation or the detection result of the sensor) from each of input sections (specifically, the buttons 103, the left stick 32, and the sensors 104 and 105). The communication control section 101 transmits operation data including the acquired information (or information obtained by performing predetermined processing on the acquired information) to the main body apparatus 2. The operation data is transmitted repeatedly, once every predetermined time. The interval at which the information regarding an input is transmitted from each of the input sections to the main body apparatus 2 may or may not be the same.

The above operation data is transmitted to the main body apparatus 2, whereby the main body apparatus 2 can obtain inputs provided to the left controller 3. That is, the main body apparatus 2 can determine operations on the buttons 103 and the left stick 32 on the basis of the operation data. Further, the main body apparatus 2 can calculate information regarding the motion and/or the orientation of the left controller 3 on the basis of the operation data (specifically, the detection results of the acceleration sensor 104 and the angular velocity sensor 105).

The left controller 3 includes a vibrator 107 for giving notification to the user by a vibration. In the exemplary embodiment, the vibrator 107 is controlled by a command from the main body apparatus 2. That is, upon receiving the command from the main body apparatus 2, the communication control section 101 drives the vibrator 107 in accordance with the received command. Here, the left controller 3 includes a codec section 106. Upon receiving the command, the communication control section 101 outputs a control signal corresponding to the command to the codec section 106. The codec section 106 generates a driving signal for driving the vibrator 107, based on the control signal from the communication control section 101, and outputs the driving signal to the vibrator 107. Consequently, the vibrator 107 is operated.

More specifically, the vibrator 107 is a linear vibration motor. Unlike a regular motor that rotationally moves, the linear vibration motor is driven in a predetermined direction in accordance with an input voltage and therefore can be vibrated at an amplitude and a frequency corresponding to the waveform of the input voltage. In the exemplary embodiment, a vibration control signal transmitted from the main body apparatus 2 to the left controller 3 may be a digital signal representing the frequency and the amplitude every unit time. In another exemplary embodiment, information indicating the waveform itself may be transmitted from the main body apparatus 2. However, transmitting only the amplitude and the frequency enables a reduction in the amount of communication data. In order to further reduce the amount of data, only differences between the numerical values of the amplitude and the frequency at the current time and the previous values may be transmitted, instead of the numerical values. In this case, the codec section 106 converts a digital signal indicating the values of the amplitude and the frequency acquired from the communication control section 101 into the waveform of an analog voltage and inputs a voltage in accordance with the resulting waveform, thereby driving the vibrator 107. Thus, the main body apparatus 2 changes the amplitude and the frequency to be transmitted every unit time and thereby can control the amplitude and the frequency at which the vibrator 107 is vibrated at that time. Not only a single amplitude and a single frequency but also two or more amplitudes and two or more frequencies may be transmitted from the main body apparatus 2 to the left controller 3. In this case, the codec section 106 combines waveforms indicated by the plurality of received amplitudes and frequencies and thereby can generate the waveform of a voltage for controlling the vibrator 107.

The left controller 3 includes a power supply section 108. In the exemplary embodiment, the power supply section 108 includes a battery and a power control circuit. Although not shown in FIG. 9, the power control circuit is connected to the battery and also connected to components of the left controller 3 (specifically, components that receive power supplied from the battery).

As shown in FIG. 9, the right controller 4 includes a communication control section 111, which communicates with the main body apparatus 2. Further, the right controller 4 includes a memory 112, which is connected to the communication control section 111. The communication control section 111 is connected to components including the terminal 64. The communication control section 111 and the memory 112 have functions similar to those of the communication control section 101 and the memory 102, respectively, of the left controller 3. Thus, the communication control section 111 can communicate with the main body apparatus 2 through both wired communication via the terminal 64 and wireless communication not via the terminal 64 (specifically, communication compliant with the Bluetooth (registered trademark) standard). The communication control section 111 controls the method for communication performed by the right controller 4 with the main body apparatus 2.

The right controller 4 includes input sections similar to the input sections of the left controller 3. Specifically, the right controller 4 includes buttons 113, the right stick 52, and inertial sensors (an acceleration sensor 114 and an angular velocity sensor 115). These input sections have functions similar to those of the input sections of the left controller 3 and operate similarly to the input sections of the left controller 3.

Furthermore, the right controller 4 includes a vibrator 117 and a codec section 116. The vibrator 117 and the codec section 116 operate similarly to the vibrator 107 and the codec section 106, respectively, of the left controller 3. That is, in accordance with a command from the main body apparatus 2, the communication control section 111 causes the vibrator 117 to operate, using the codec section 116.

The right controller 4 includes a power supply section 118. The power supply section 118 has a function similar to that of the power supply section 108 of the left controller 3 and operates similarly to the power supply section 108.

### Outline of Game Processing of Exemplary Embodiment

Next, an outline of operation of game processing executed in the game system 1 according to the exemplary embodiment will be described. As described above, in the game system 1, the left controller 3 and the right controller 4 are attachable to and detachable from the main body apparatus 2. When a game is played with the left controller 3 and the right controller 4 being attached to the main body apparatus 2, a game image is outputted to the display 12. Meanwhile, when the main body apparatus 2 alone from which the left controller 3 and the right controller 4 are detached is attached to the cradle, the main body apparatus 2 can also output the game image to a stationary monitor or the like via the cradle. In the exemplary embodiment, an example case where game play is performed in the latter form will be described. Specifically, in this form, the main body apparatus 2 alone from which the left controller 3 and the right controller 4 are detached is attached to the cradle, and the main body apparatus 2 outputs the game image and the like to a stationary monitor or the like via the cradle.

Hereinafter, the left controller 3 and the right controller 4 will occasionally be referred to collectively as a “controller”.

### Assumed Game

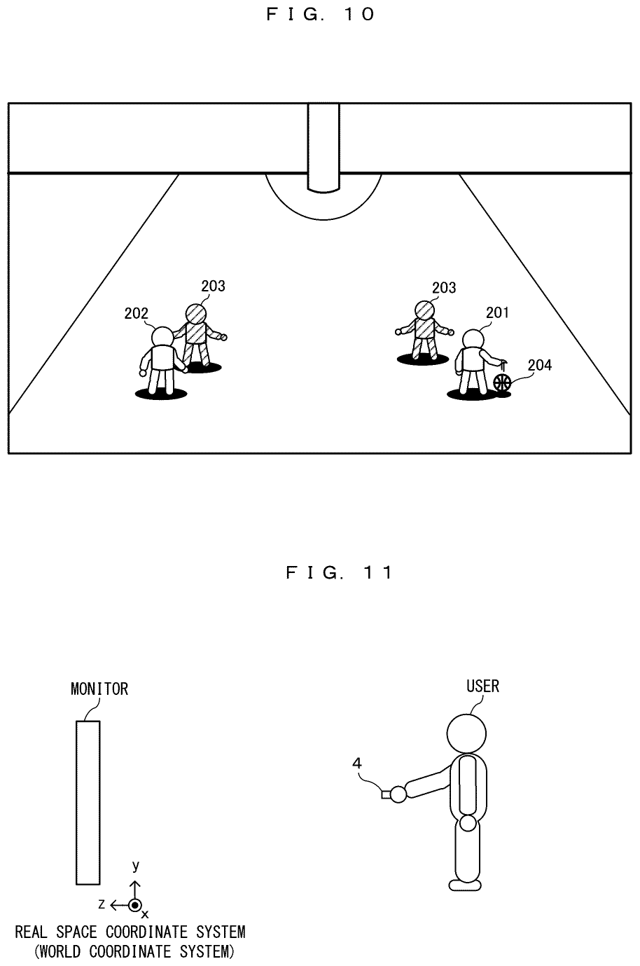

Next, an outline of a game assumed in the exemplary embodiment will be described. The game assumed in the exemplary embodiment is a ball sport game. In the exemplary embodiment, a basketball game will be described as an example of the ball sport game. In the exemplary embodiment, a 2-on-2 communication match basketball game is assumed. FIG. 10 shows an example of a game screen of the basketball game (hereinafter simply referred to as “this game”) in the exemplary embodiment. FIG. 11 shows an example of the posture of the user (controller) when playing this game. Each of the examples assumes the case immediately after the start of game play.

In this game, the user operates a player character object (hereinafter referred to as “PC”) by using the right controller 4 or the left controller 3. In the exemplary embodiment, game play is started with, as an initial posture (reference posture), the leading end side of the controller to be used for play being directed to a monitor (the positive direction of the z axis in a real space coordinate system in FIG. 11; hereinafter referred to as “real space forward direction), and the main surface of the controller being directed upward in the real space (the positive direction of the y axis in the real space coordinate system in FIG. 11; hereinafter referred to as “real space upward direction”). In the case where the right controller 4 is used for play, the leading end side of the controller is the side on which the first R-button 60 and the ZR button 61 are disposed (the positive direction of the y axis in FIG. 7). When the left controller 3 is used for play, the leading end side is the side on which the first L-button 38 and the ZL button 39 are disposed (the positive direction of the y axis in FIG. 6). The following description will be basically given for the case where the user plays the game with the right controller 4, and the case of using the left controller 3 will be described according to need.

Next, the screen example shown in FIG. 10 will be described. In FIG. 10, a PC 201, an ally character 202, and two enemy characters (hereinafter referred to as “EC”) 203 are present on the field of the virtual space imitating a basketball court. Motions of the ally character 202 and the ECs 203 are controlled based on operations performed by the other users as communication partners. On the far side of the screen, a part of a goal post is displayed. The PC 201 has a ball 204, and is dribbling the ball 204 in place. Here, game play is started in the state where the player character has the ball.

### Outline of Stop State and Moving State

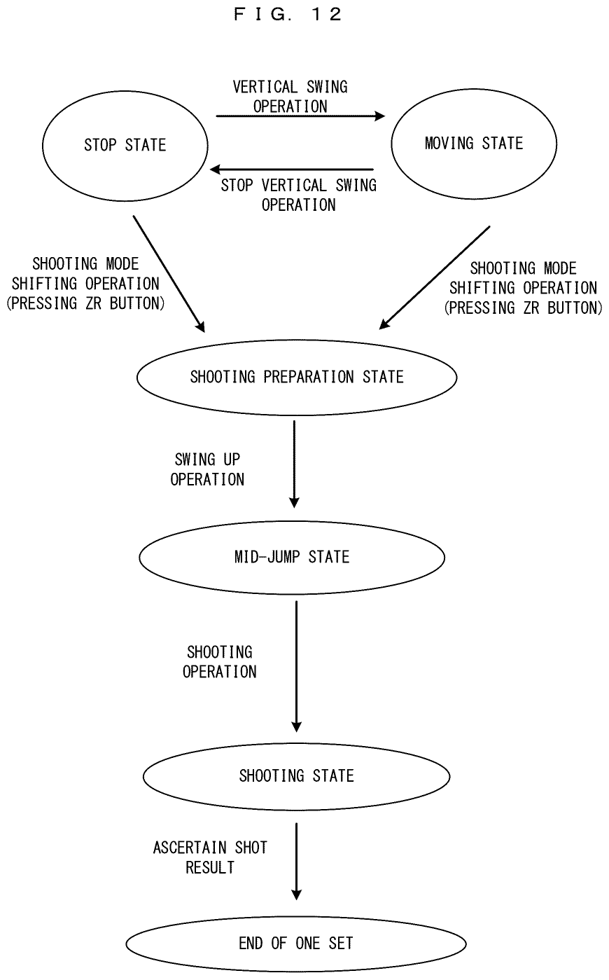

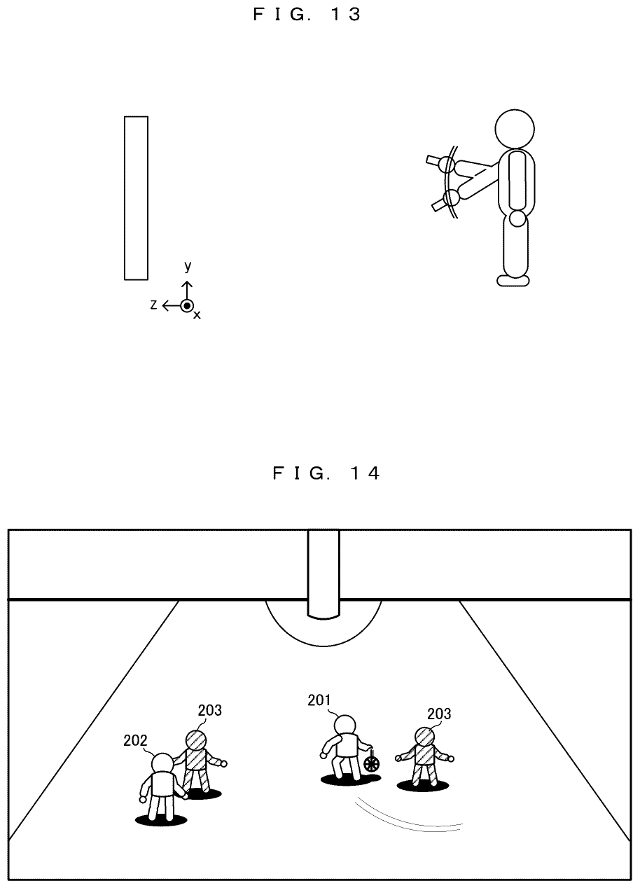

Next, a rough flow of play and an operation example in this game will be described. FIG. 12 schematically shows transition of the state of the PC 201 (hereinafter referred to as “PC state”) along with the flow of play of this game. Immediately after the start of game play, the PC 201 is in a “stop state”. The stop state is a state in which the PC 201 does not move, and is performing a motion of dribbling in place. In this stop state, as shown in FIG. 13, if the user performs an operation of swinging the right controller 4 in the up-down direction in the real space, with the leading end of the right controller 4 being roughly directed forward (hereinafter referred to as “vertical swing operation”), the PC state is caused to transition to the “moving state”. Thereafter, while the user continues the vertical swing operation, the moving state is maintained. The moving state is a state in which the PC 201 is moving while dribbling toward a predetermined target spot on the field, specifically, a predetermined spot under a goal ring. In other words, the PC 201 is performing a dribbling motion while moving. FIG. 14 shows a screen example in which the PC 201 is in the moving state. In FIG. 14, the PC 201 is moving toward the spot under the goal ring while evading the ECs 203.

A movement path of the PC 201 in the moving state is calculated as follows. That is, first, a straight-line distance from the current position of the PC 201 to the above target spot is calculated as the path. If an obstacle such as an EC is present on this straight line, a path that bypasses the obstacle is calculated. If there is no such obstacle, the straight-line path is used.

When the PC 201 is in the moving state, the PC 201 can be caused to transition to the stop state by the user stopping the vertical swing operation. Transition to the stop state allows the PC 201 to stop movement, and perform a dribbling motion in place.

### Shooting Mode

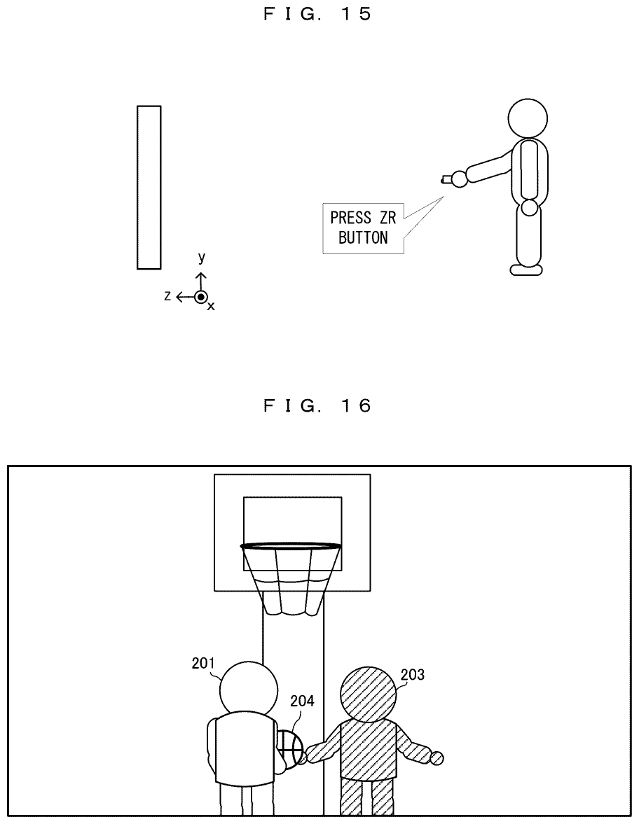

Referring back to FIG. 12, the description for “shooting” will be given. When the PC 201 is in the stop state or the moving state, if the user performs a shooting mode shifting operation, the PC 201 enters the shooting mode. The shooting mode is a mode for attempting a shot, and includes three states, “shooting preparation state”, “mid-jump state”, and “shooting state” described below. When the user has performed the shooting mode shifting operation, first, the PC state transitions to the “shooting preparation state”. The shooting preparation state is a state in which the PC 201 stands by while holding the ball 204. In this embodiment, the shooting mode shifting operation is pressing the ZR button 61 when the right controller 4 is used, and is pressing the ZL button 39 when the left controller 3 is used. For example, as shown in FIG. 15, when the user has pressed the ZR button 61, a screen for the shooting mode as shown in FIG. 16 is displayed. Before entering the shooting mode, a virtual camera is located at a position such that the field is captured in a relatively wide range as shown in FIG. 10 and FIG. 14. On the other hand, during the shooting mode, the virtual camera is moved to a position behind the PC 201 such that the goal ring is displayed within the screen while being somewhat zoomed up.

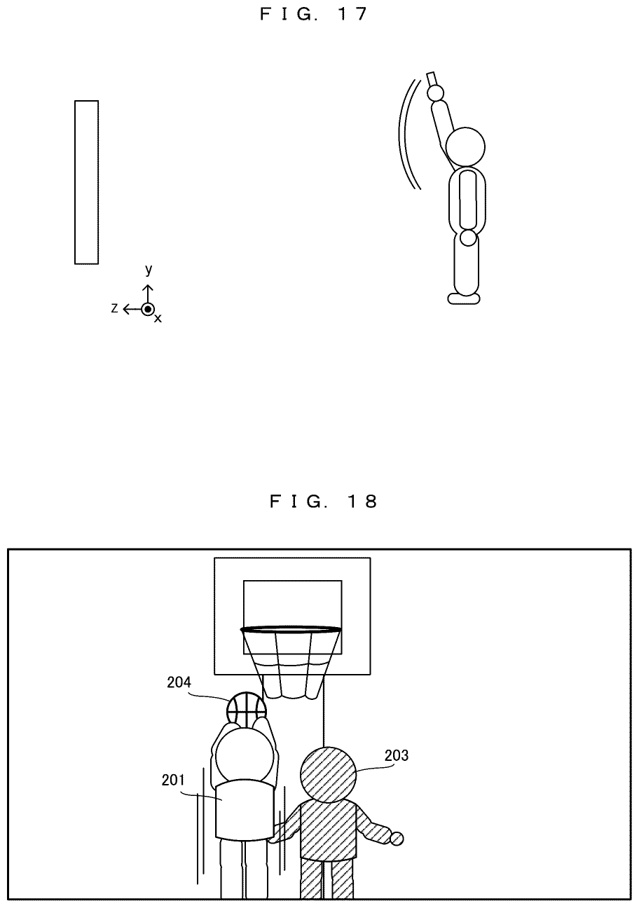

If the user performs a “swing up operation” within a predetermined time period from the transition of the PC 201 into the shooting preparation state, the PC state transitions to the “mid-jump state”. The swing up operation is an operation of swinging up the right controller 4 in the real space upward direction as shown in FIG. 17. The mid-jump state is a state in which the PC 201 is performing a motion of jumping while raising the ball up (hereinafter referred to as “jumping motion”) as shown in FIG. 18. In the exemplary embodiment, if the swing up operation is not performed within the predetermined time period, this situation is treated as a failure in shooting at that point in time (treated as a kind of violation).

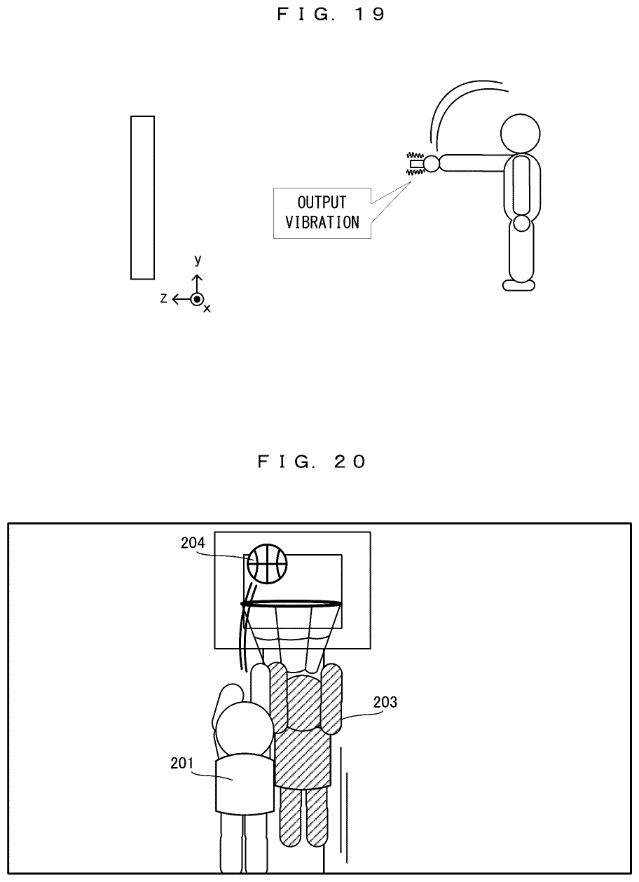

The mid-jump state continues until the motion of jumping ends (until the PC 201 lands). During the mid-jump state, if the user performs an operation of swinging down the right controller 4 in the real space forward direction (hereinafter referred to as “shooting operation”) as shown in FIG. 19, the PC state transitions to the “shooting state”. During the shooting operation, a vibration is outputted to the right controller 4 (this vibration will be described later). The shooting state is a state after the PC 201 has shot the ball 204 as shown in FIG. 20. In the shooting state, the PC 201 starts a “shooting motion”, i.e., shooting the ball 204 toward the goal post, and the ball 204 starts to move accordingly. The movement trajectory of the ball 204 in the shooting state is calculated based on an acceleration and an angular velocity detected by the right controller 4 when the shooting operation was performed. In the exemplary embodiment, if the shooting operation is not performed during the mid-jump state, this situation is also treated as a failure in shooting.

### Block Action

Here, a “block action” that the EC 203 performs during the shooting mode will be described. FIG. 16, FIG. 18, and FIG. 20 each show a state in which the EC 203 is present just near the PC 201. The EC 203 may perform a block action of jumping with both hands being raised as shown in FIG. 20 in accordance with the shooting motion of the PC 201. This block action is performed based on a predetermined operation (hereinafter referred to as “block operation”) by an opponent player operating the EC 203. For example, an operation of swinging the controller upward is the block operation. If the block operation is performed at the right time, the shot of the PC 201 is blocked. This situation is also treated as a failure in shooting.

FIG. 16, FIG. 18, and FIG. 20 each show a case in which the PC 201 (user) is on the offense side. When the PC 201 is on the defense side, the user can defend against a shot of the opponent team by performing the block operation.

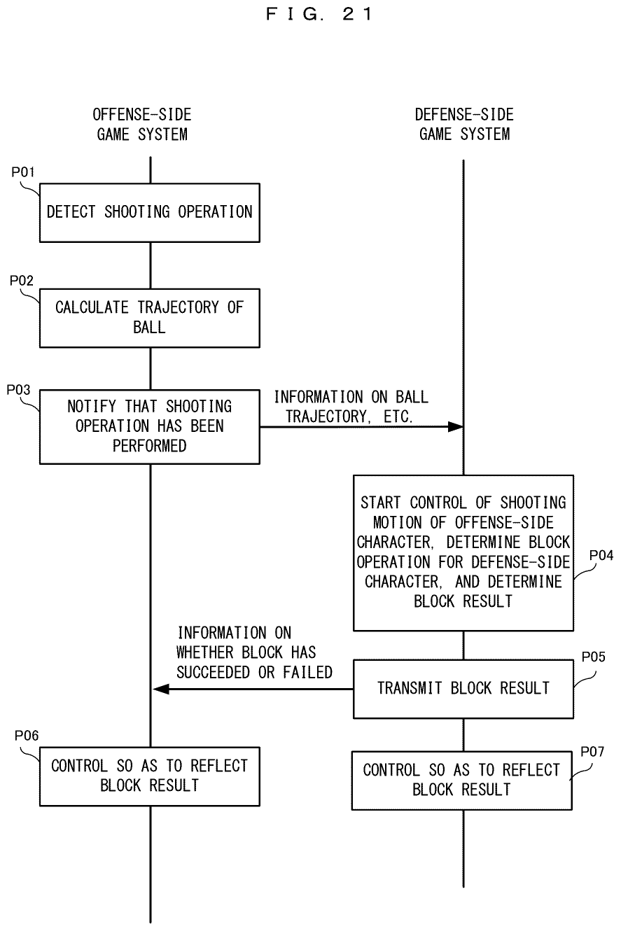

Here, further details of a process regarding whether or not a block has succeeded, will be described. FIG. 21 shows an outline of a flow of processing after the shooting operation has been performed. In FIG. 21, processing performed in the game system 1 on the offense side (the PC 201 having the ball 204) is shown on the left side, and processing performed in the game system 1 on the defense side is shown on the right side. In the exemplary embodiment, the defense-side game system determines whether or not a block has succeeded, and returns the result to the offense-side game system. Specifically, first, the offense-side game system 1 detects a shooting operation (P01). Next, the trajectory of the ball 204 is calculated based on the posture and swing speed of the controller during the shooting operation (P02). Next, game data including: the fact that the shooting operation has been performed; and information on the trajectory of the ball, is transmitted from the offense-side game system 1 to the defense-side game system 1 (P03).

Next, in the defense-side game system 1, based on the received game data, a motion regarding shooting of the PC 201 (offense-side character) in the defense-side game system 1 and movement control for the ball 204 are started. Furthermore, determination as to whether or not the block operation has been performed in the defense-side game system 1 is performed. When the block operation has been performed, determination on the block result as to whether or not the block of the shot has succeeded, is also performed based on the timing, etc., of the block operation (P04).

After the block result has been ascertained, information indicating the details thereof is transmitted from the defense-side game system 1 to the offense-side game system 1 (P05).

Next, in the offense-side game system 1, based on the received block result, motion control for the EC 203 in the offense-side game system 1 is performed such that representation reflecting the block result is performed (P06). Furthermore, in the defense-side game system 1 as well, operation control for the PC 201 and the ball 204 is performed such that representation reflecting the block result is performed (P07).

After the shooting operation as described above has been performed, a shot result as to whether or not the shot has succeeded is ascertained, and one set of play ends. In the exemplary embodiment, the shot is determined to be successful when the ball 204 has passed through the goal ring. If the shot is blocked or if the ball 204 does not pass through the goal ring although it is not blocked, it is determined that the shot has failed. After the shot result has been ascertained, the next set of play is started, and the screen as shown in FIG. 10 is displayed.

Points for a successful shot are determined based on the position of the PC 201 on the field when the PC 201 is in the shooting preparation state. For example, when the PC 201 has made a shot from outside a semicircle area under the goal ring set as a “3-point area”, 3 points are given.

As described above, the game flow according to the exemplary embodiment includes: causing the PC 201 to move toward the goal ring through the vertical swing operation; causing the PC 201 to transition to the shooting preparation state at an appropriate timing; causing the PC 201 to attempt a shot through a series of operations, i.e., the swing up operation and the swing down operation; and ending one set of play upon receiving the shot result.

### Communication Delay

Incidentally, the basketball game according to the exemplary embodiment is a communication match game as described above. In order to synchronize the game progress of each player, data including operation information and the like of each player in each game system is transmitted and received. However, in communication between the game systems, it is conceivable that a communication delay may occur. In the exemplary embodiment, taking such a communication delay into consideration, control as follows is performed for the processing regarding the block action as shown in FIG. 21.

In the exemplary embodiment, even when a shooting operation has been detected in the offense-side game system 1, the shooting motion and movement of the ball 204 are not performed immediately at the detection timing, but are performed after a delay of a predetermined period according to a communication delay. The reason is as follows. That is, if the shooting motion and movement of the ball 204 are started immediately at the detection timing of the shooting operation, the communication delay may cause uncomfortable display in the offense-side game system 1. For example, even in the case where a block has succeeded in actuality, there is a possibility of occurrence of display in which the ball 204 is hit although the EC 203 seems not to perform a block motion or seems to perform a block motion with a delay, or display in which the position of the ball is suddenly changed. On the contrary, in the case where the timing of a block is too early, there is a possibility of occurrence of display in which the ball 204 seems to hit the EC 203 although the block has not succeeded in actuality, or display in which the ball 204 moves passing through the body of the EC 203. As described above, in the exemplary embodiment, the offense-side game system 1 notifies the defense-side game system 1 of a shot having been performed, the defense-side game system 1 determines whether or not a block action has succeeded, and the offense-side game system 1 receives the result. Taking the communication delay into consideration, there is a time lag corresponding to the communication delay from the notification of the shot from the offense-side game system 1 to the defense-side game system 1 to the reception of the result of the block action. Therefore, if movement of the ball 204 is started immediately after the detection of the shooting operation, the ball 204 moves some distance until the result of the block action is received. As a result, at the timing when the result of the block action is received and the EC 203 is caused to perform a block motion so as to reflect the result, the position of the ball 204 may have advanced toward the goal post side with respect to the position of the EC 203. This may result in an unnatural display as described above. In view of this, in the exemplary embodiment, the timing to start the shooting motion and movement of the ball 204 is controlled to be delayed from the shooting operation detection timing by a period corresponding to the communication delay. This provides a margin for receiving the result of the block action, and makes uncomfortable representation less likely to occur.

In the exemplary embodiment, the start of the shooting motion and the start of movement of the ball 204 are controlled to be performed at the same timing. The reason is as follows. That is, if the start timings do not coincide with each other, there is a possibility that the user may feel visual discomfort such that the ball 204 is not moving although the PC 201 performs a motion of throwing the ball 204. In particular, when a motion of throwing a ball held in hands, such as shooting of a basketball, is represented, if a deviation between the motion of throwing the ball and the movement start timing of the ball is great, the visual discomfort is increased. Therefore, it is effective to make the timing to start the shooting motion coincide with the timing to start movement of the ball 204.

### Vibration

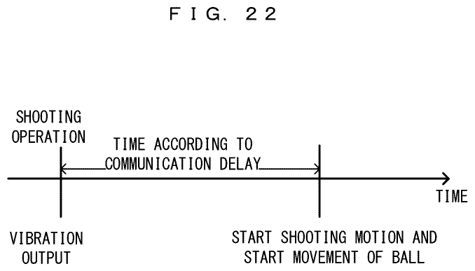

In the exemplary embodiment, when the shooting operation is performed, control for vibrating the controller (output of a vibration signal) is also performed as shown in FIG. 19. This allows the user to intuitively know that the shooting operation has been performed (a shot has been attempted). Regarding the timing to vibrate the controller, in the exemplary embodiment, control is performed so as to vibrate the controller not at the start of the shooting motion but at the timing when the shooting operation is detected. FIG. 22 schematically shows the relationship between timing when a shooting operation has been performed, vibration output timing, and timing to start a shooting motion and movement of the ball 204, according to the exemplary embodiment. In FIG. 22, vibration output is performed when a shooting operation is performed, and thereafter, a shooting motion and movement of the ball 204 are started when a time corresponding to a communication delay has elapsed. In the case where the vibration is outputted at the timing as shown in FIG. 22, to be precise, the vibration is outputted when the shooting operation is detected, but the PC 201 is still in the posture of jumping in the game screen regarding the frame at that time, and the shooting motion has not yet been started. That is, the actual shooting motion is started with a delay with respect to the shooting operation, to be precise, the shooting operation does not coincide with the visual feedback for the shooting operation, resulting in a slight deviation. In this regard, for example, it is conceivable to make the vibration output timing coincide with the shooting motion start timing. In this case, however, although tactile feedback and visual feedback due to the vibration coincide with each other, since both of them are delayed, the feeling of delay becomes significant as a whole. However, as described above, by outputting only the vibration when the shooting operation has been detected to make the user physically feel that the shooting operation has been done, the feeling of discomfort due to the delay in the visual feedback can be reduced. That is, since the user is given the tactile feedback in advance through the vibration, the user can intuitively recognize that a shot has been attempted. Therefore, even if the visual feedback is somewhat delayed, the user does not feel the delay, or feels less discomfort.

### Details of Game Processing of Exemplary Embodiment

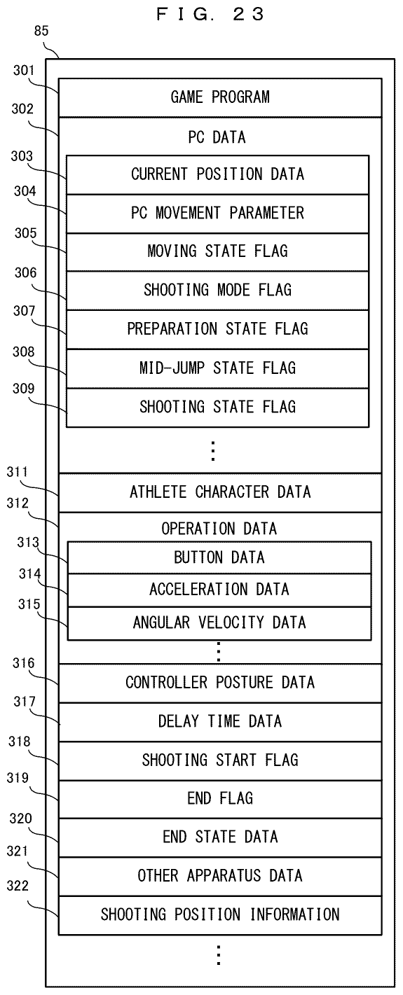

Next, the game processing according to the exemplary embodiment will be described in more detail with reference to FIG. 23 to FIG. 31. Here, a process of controlling the PC 201 (offensive PC 201) having the ball 204 will be mainly described, while description of the details of the defensive PC 201 and the other game processes will be omitted. In addition, in the following description, the case of using the right controller 4 will be described as an example.

### Data to be Used

First, various kinds of data to be used in this game processing will be described. FIG. 23 is a memory map showing an example of various kinds of data stored in the DRAM 85 of the main body apparatus 2. The DRAM 85 of the main body apparatus 2 has, stored therein, a game program 301, PC data 302, athlete character data 311, operation data 312, controller posture data 316, delay time data 317, a shooting start flag 318, an end flag 319, end state data 320, other apparatus data 321, shooting position information 322, and the like.

The game program 301 is a program for executing the game processing of the exemplary embodiment.

The PC data 302 includes current position data 303, a PC movement parameter 304, a moving state flag 305, a shooting mode flag 306, a preparation state flag 307, a mid-jump state flag 308, a shooting state flag 309, and the like. The PC data 302 also includes various kinds of data required for the game processing, such as data (polygon data) indicating the appearance of the PC 201 and various kinds of motion data (animation data) that the PC 201 performs, although these data are not shown.

The current position data 303 is data indicating the current position of the PC 201 on the field.

The PC movement parameter 304 is data used for controlling movement of the PC 201. For example, the PC movement parameter includes parameters indicating a movement direction, a movement speed, etc., of the PC 201.

The moving state flag 305 is a flag indicating whether the PC state is the moving state or the stop state. The moving state flag 305 indicates the moving state when it is ON, and indicates the stop state when it is OFF. The initial value of the moving state flag 305 is OFF.

The shooting mode flag 306 is a flag indicating whether or not the current mode is the shooting mode. The shooting mode flag 306 indicates that the current mode is the shooting mode when it is ON, and indicates that the current mode is not the shooting mode when it is OFF. The initial value of the shooting mode flag 306 is OFF.

The preparation state flag 307 is a flag indicating whether or not the PC state is the shooting preparation state. The preparation state flag 307 indicates that the PC state is the shooting preparation state when it is ON, and indicates that the PC state is not the shooting preparation state when it is OFF. The initial value of the preparation state flag 307 is OFF.

The mid-jump state flag 308 is a flag indicating whether or not the PC state is the mid-jump state. The mid-jump state flag 308 indicates that the PC state is the mid-jump state when it is ON, and indicates that the PC state is not the mid-jump state when it is OFF. The initial value of the mid-jump state flag 308 is OFF.

The shooting state flag 309 is a flag indicating whether or not the PC state is the shooting state. The shooting state flag 309 indicates that the PC state is the shooting state when it is ON, and indicates that the PC state is not the shooting state when it is OFF. The initial value of the shooting state flag 309 is OFF.

Next, the athlete character data 311 is data regarding character objects other than the PC 201, specifically, the ally character 202 and the ECs 203. The athlete character data 311 includes various kinds of parameters for controlling the motion of each character object.

Next, the operation data 312 is data obtained from the controller operated by the user. That is, the operation data 312 indicates the details of operations performed by the user. Here, the data obtained from the right controller 4 will be described as an example. When the left controller 3 is used, the operation data regarding the left controller 3 is obtained. The operation data 312 includes at least button data 313, acceleration data 314, and angular velocity data 315. The button data 313 is data indicating the press states of various types of buttons included in the right controller 4. The acceleration data 314 indicates the detection results of the acceleration sensor 114, and the angular velocity data 315 indicates the detection result of the angular velocity sensor 115.

Next, the controller posture data 316 is data regarding the current posture of the controller.

The delay time data 317 is data indicating the communication delay time as described above. In the exemplary embodiment, as described later, a delay time is measured and specified in processing for each frame, and is stored as the delay time data 317.

The shooting start flag 318 is a flag indicating whether the current state is before or after (shooting state) the shooting operation. The shooting start flag 318 is set to ON when the shooting operation has been performed. The initial value thereof is OFF.

The end flag 319 is a flag indicating whether or not the result of the shot has been ascertained. The initial value of the end flag 319 is OFF, and the end flag 319 is set to ON when the result of the shot has been ascertained.

The end state data 320 is data indicating whether or not the shot has succeeded (points are obtained) or failed.

The other apparatus data 321 is data in which data received from other game systems 1 in the session regarding the current match are temporarily stored. The other apparatus data 321 includes various kinds of information such as the details of operations performed in the other game systems 1, and the results of block actions.

The shooting position information 322 is data indicating the position, on the field, of the PC 201 when the PC state has transitioned to the shooting preparation state.

In addition, various kinds of data required for the game processing, such as data regarding the ball 204 (appearance data and a parameter for movement control) and the score status, are generated as appropriate and stored in the DRAM 85, although these data are not shown.

### Details of Processing Executed by Processor

Next, the details of the game processing according to the exemplary embodiment will be described. Here, a case in which the user plays the game by using the right controller 4 will be described as an example. Flowcharts described below are merely an example of the processing. Therefore, the order of each process step may be changed as long as the same result is obtained. In addition, the values of variables and thresholds used in determination steps are also merely examples, and other values may be used as necessary.

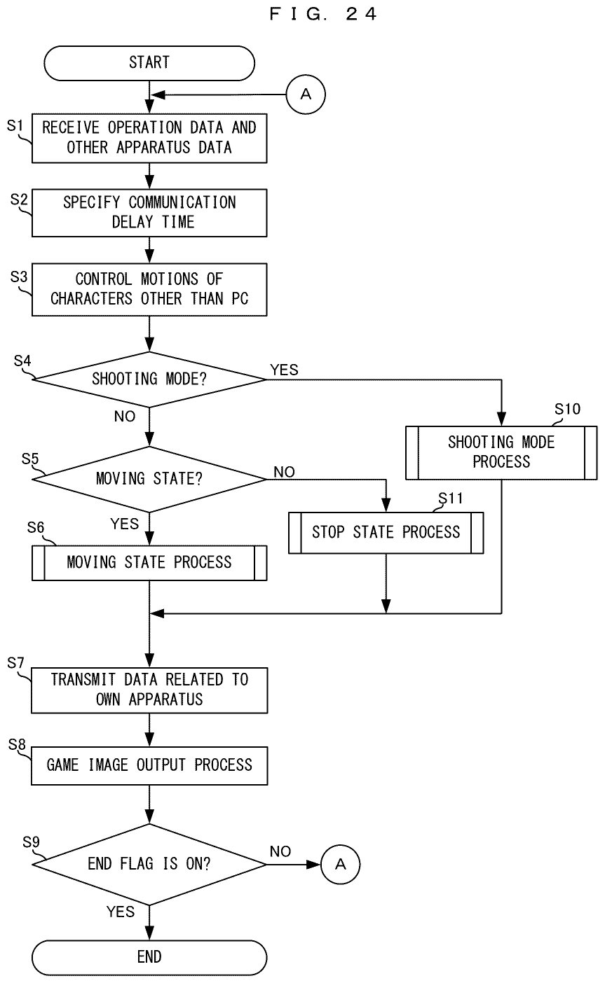

FIG. 24 is a flowchart showing the details of the game processing according to the exemplary embodiment. A process loop of steps S1 to S9 in FIG. 24 is repeated a predetermined number of times in one second according to the frame rate. In FIG. 24, first, in step S1, the processor 81 acquires the operation data 312. Furthermore, the processor 81 receives the other apparatus data 321 from the other game systems 1.

Next, in step S2, the processor 81 specifies a communication delay time, and stores the same as delay time data 317. This specification may be performed by any method. For example, in receiving the other apparatus data 321, a delay time in the current frame is measured, an average value of delay times over several frames is calculated, and this average value is specified as a delay time.

Next, in step S3, the processor 81 controls the motions of the characters other than the PC 201, based on the received other apparatus data 321. For example, if the other apparatus data 321 includes information on the result of a block action, control for causing the EC 203 to perform a block action is performed.

Next, in step S4, the processor 81 determines whether or not the shooting mode flag 306 is ON. If the determination result is that the shooting mode flag 306 is OFF (NO in step S4), the processor 81 determines in step S5 whether or not the moving state flag 305 is ON. If the determination result is that the moving state flag 305 is OFF (NO in step S5), the processor 81 performs a stop state process in step S11. On the other hand, if the moving state flag 305 is ON (YES in step S5), the processor 81 performs a moving state process in step S6. Hereinafter, the stop state process and the moving state process will be described in order.

### Stop State Process

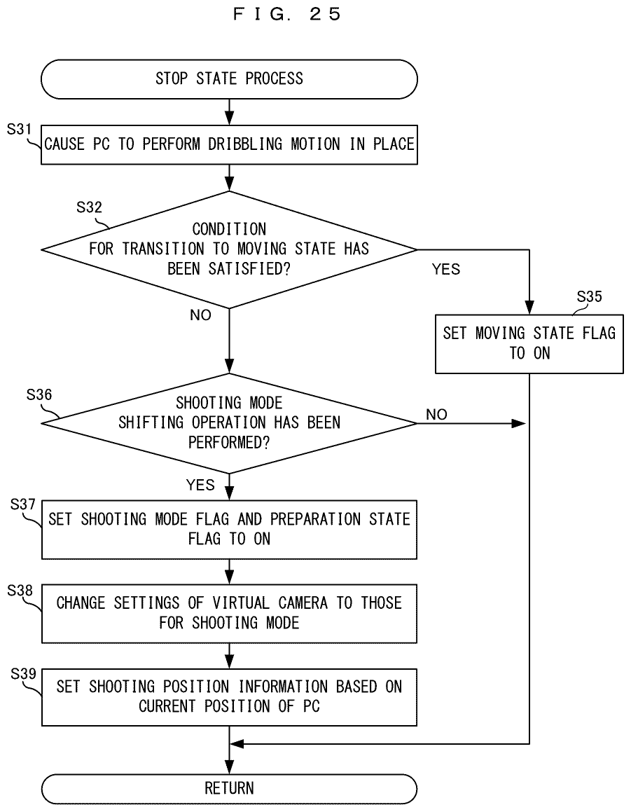

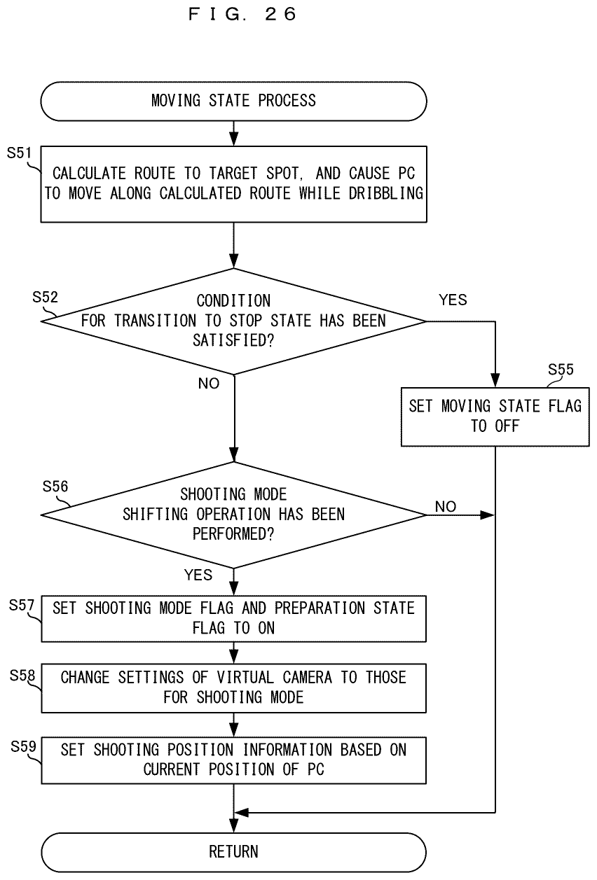

FIG. 25 is a flowchart showing the details of the stop state process. First, in step S31, the processor 81 causes the PC 201 to perform a dribbling motion in place.

Next, in step S32, the processor 81 determines whether or not the condition for transition from the stop state to the moving state has been satisfied. For example, it is determined whether or not the vertical swing operation has been started, and if the vertical swing operation has been started, it is determined that the condition for transition to the moving state has been satisfied. When the determination result is that the condition for transition to the moving state has been satisfied (YES in step S32), the processor 81 sets the moving state flag 305 to ON in step S35. Thereafter, the processor 81 ends the stop state process.

On the other hand, when the condition for transition to the moving state has not been satisfied (NO in step S32), the processor 81, in step S36, based on the operation data 312, determines whether or not the shooting mode shifting operation has been performed. When the determination result is that the shooting mode shifting operation has been performed (YES in step S36), the processor 81 sets the shooting mode flag 306 and the preparation state flag 307 to ON in step S37. Next, in step S38, the processor 81 changes the various kinds of settings of the virtual camera to those for the shooting mode.

Next, in step S39, the processor 81 sets shooting position information 322 based on the current position of the PC 201 on the field. Thereafter, the processor 81 ends the stop state process.

On the other hand, when the determination result in step S36 is that no shooting mode shifting operation has been performed (NO in step S36), the processes in the above steps S37 to S39 are skipped to end the stop state process.

### Moving State Process

Next, the moving state process will be described. FIG. 26 is a flowchart showing the details of the moving state process. First, in step S51, the processor 81 calculates a route from the current position of the PC 201 to the target spot (e.g., under the goal ring). Then, the processor 81 moves the PC 201 (and the ball 204) along the route while causing the PC 201 to perform a dribbling motion. After reaching the target spot, the PC 201 is controlled not to advance further and to perform a dribbling motion in place.

Next, in step S52, the processor 81 determines whether or not the condition for transition from the moving state to the stop state has been satisfied. For example, it is determined based on the operation data 312 whether transition from the state where the vertical swing operation is performed to the state where the vertical swing operation is stopped, has been made. If such transition has been made, it is determined that the condition for transition to the stop state has been satisfied. When the determination result is that the condition for transition to the stop state has been satisfied (YES in step S52), the processor 81 sets the moving state flag 305 to OFF in step S55. Thereafter, the processor 81 ends the moving state process.

On the other hand, when the condition for transition to the stop state has not been satisfied (NO in step S52), the processor 81, in step S56, based on the operation data 312, determines whether or not the shooting mode shifting operation has been performed. When the determination result is that the shooting mode shifting operation has been performed (YES in step S56), in steps S57 to S59, the same processes as in steps S37 to S39 shown in FIG. 25 are performed. Meanwhile, when no shooting mode shifting operation has been performed (NO in step S56), the processes in steps S57 to S59 are skipped to end the moving state process.

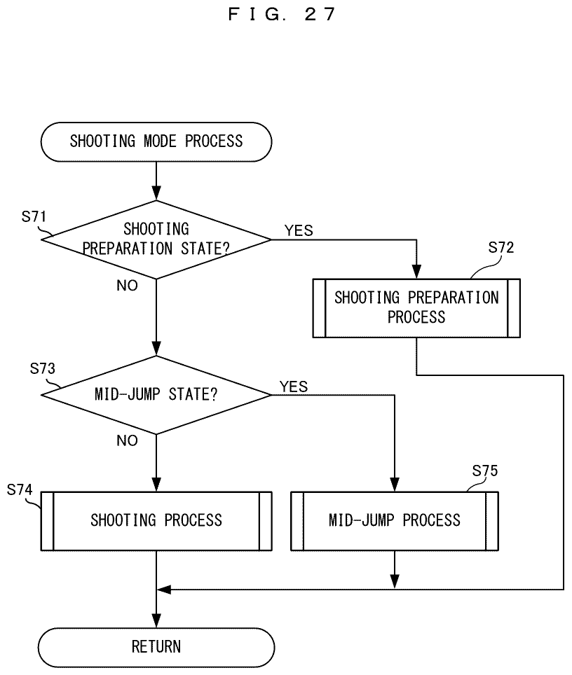

Referring back to FIG. 24, a process to be performed when the determination result in step S4 is the “shooting mode” (YES in step S4) will be described. In this case, the processor 81 executes a shooting mode process in step S10. FIG. 27 is a flowchart showing the details of the shooting mode process. In FIG. 27, first, in step S71, based on the preparation state flag 307, the processor 81 determines whether or not the PC state is the shooting preparation state. When the determination result is that the PC state is the shooting preparation state (YES in step S71), the processor 81 executes a shooting preparation process in step S72.

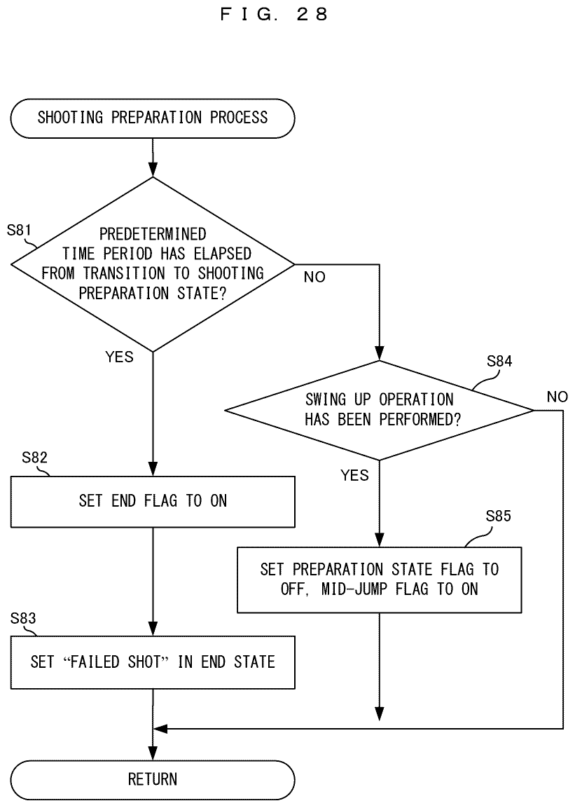

FIG. 28 is a flowchart showing the details of the shooting preparation process. In FIG. 28, first, in step S81, the processor 81 determines whether or not a predetermined time period has elapsed from when the preparation state flag 307 was set to ON, i.e., from the transition to the shooting preparation state. When the determination result is that the predetermined time has elapsed (YES in step S81), a process for ending one set of play is performed on the assumption that a shot has failed. First, in step S82, the processor 81 sets the end flag 319 to ON. Next, in step S83, the processor 81 sets “failed shot” in the end state data 320. Thereafter, the shooting preparation process is ended.

On the other hand, when the determination result in step S81 is that the predetermined time has not elapsed from the transition to the shooting preparation state (NO in step S81), the processor 81, in step S84, based on the operation data 312, determines whether or not an operation of swinging the controller in the real space upward direction (aforementioned swing up operation) has been performed. When the determination result is that the swing up operation has been performed (YES in step S84), in step S85, the processor 81 sets the preparation state flag 307 to OFF, and sets the mid-jump state flag 308 to ON. On the other hand, when the swing up operation has not been performed (NO in step S84), the process in step S85 is skipped. Thereafter, the shooting preparation process is ended.

Referring back to FIG. 27, when the determination result in step S71 is that the PC state is not the shooting preparation state (NO in step S71), the processor 81 determines whether or not the PC state is the mid-jump state, in step S73, based on the mid-jump state flag 308. When the determination result is that the PC state is the mid-jump state (YES in step S73), the processor 81 executes a mid-jump process in step S75.

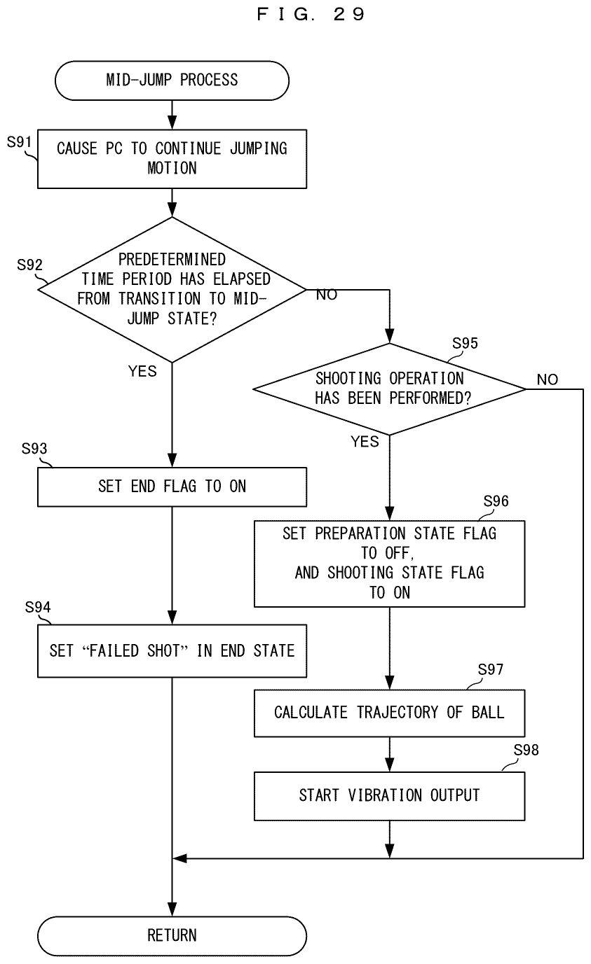

FIG. 29 is a flowchart showing the details of the mid-jump process. In FIG. 29, first, in step S91, the processor 81 causes the PC 201 to perform a jumping motion. Next, in step S92, the processor 81 determines whether or not a predetermined time has elapsed from when the PC state transitioned to the mid-jump state. The predetermined time is, for example, a time from when the jumping motion (reproduction of animation) of the PC 201 is started to when the jumping motion is ended. When the determination result is that the predetermined time has not elapsed (NO in step S92), the processor 81, in step S95, based on the operation data 312, determines whether or not the shooting operation has been performed. When the determination result is that the shooting operation has been performed (YES in step S95), the processor 81, in step S96, sets the mid-jump state flag 308 to OFF, and sets the shooting state flag 309 to ON. Next, in step S97, the processor 81 calculates the trajectory of the ball. In the exemplary embodiment, the trajectory of the ball is calculated based on the posture, the swing speed, etc., of the controller in the shooting operation.

Next, in step S98, the processor 81 starts to output a vibration signal for vibrating the controller, to the controller. This allows the vibration to start when a shooting operation is detected. Thereafter, the mid-jump process is ended.

On the other hand, when the determination result in step S95 is that no shooting operation has been performed (NO in step S95), the processes in steps S96 to S98 are skipped to end the mid-jump process.

Next, a process to be performed when the determination result in step S92 is that the predetermined time has elapsed from when the PC state transitioned to the mid-jump state (YES in step S92) will be described. This case corresponds to a case in which, after the transition to the mid-jump state, the jumping motion is ended without attempting a shot. Therefore, a process for ending one set of play is performed on the assumption that a shot has failed. Specifically, in step S93, the processor 81 sets the end flag 319 to ON. Next, in step S94, the processor 81 sets “failed shot” in the end state data 320. Thereafter, the mid-jump process is ended.

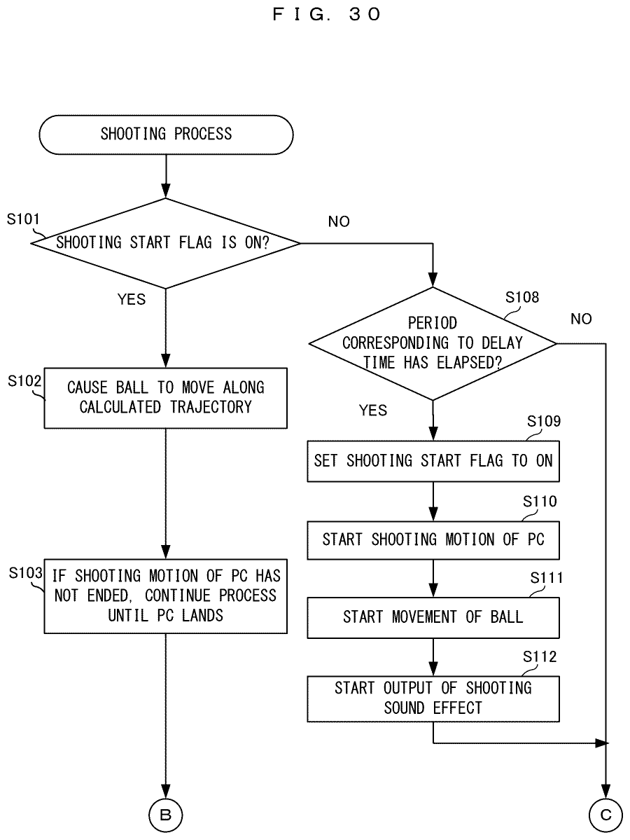

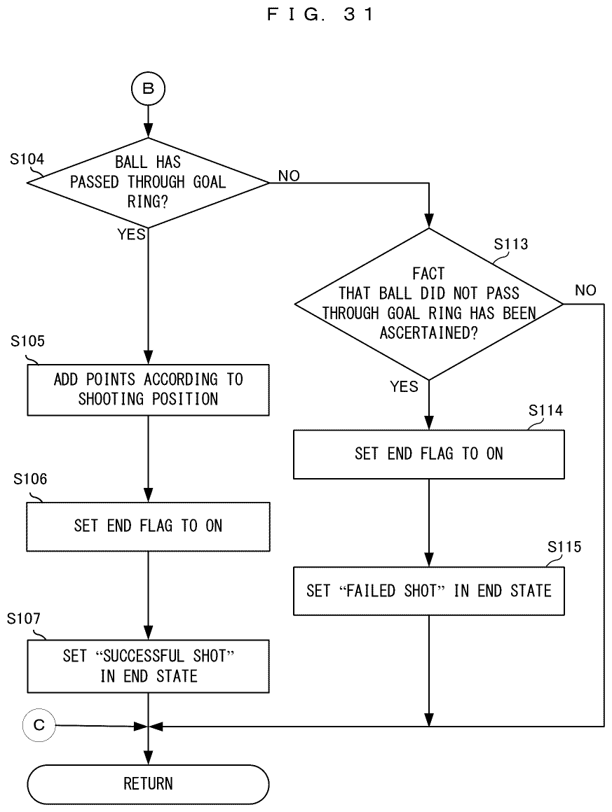

Referring back to FIG. 27, when the determination result in step S73 is that the mid-jump state flag 308 is OFF (NO in step S73), the processor 81 executes a shooting process in step S74. FIG. 30 and FIG. 31 are flowcharts showing the details of the shooting process. In FIG. 30, first, in step S101, the processor 81 determines whether or not the shooting start flag 318 is ON. When the determination result is that the shooting start flag 318 is not ON (NO in step S101), the processor 81, in step S108, determines whether or not a period corresponding to a delay time has elapsed from when the shooting operation was performed. The period corresponding to the delay time is calculated based on the delay time data 317. For example, a time equal to the specified delay time may be used as the period corresponding to the delay time.

When the determination result is that the period corresponding to the delay time has not elapsed (NO in step S108), the processor 81 ends the shooting process. On the other hand, when the period corresponding to the delay time has elapsed (YES in step S108), the processor 81 sets the shooting start flag 318 to ON in step S109.

Next, in step S110, the processor 81 starts the shooting motion of the PC 201. Next, in step S111, the processor 81 starts movement of the ball 204 based on the calculated trajectory of the ball.

Next, in step S112, the processor 81 starts output of a predetermined sound effect associated with the shooting operation in advance (hereinafter, shooting sound effect). Thus, the user is provided with acoustic feedback in accordance with the start of the shooting motion. Thereafter, the processor 81 ends the shooting process.

On the other hand, when the determination result in step S101 is that the shooting start flag 318 is ON (YES in step S101), the processor 81, in step S102, moves the ball 204 along the calculated trajectory of the ball. At this time, if the other apparatus data 321 includes a determination result of a block action, the processor 81 recalculates the trajectory of the ball 204 according to the result. That is, a trajectory in which the ball 204 is blocked by the EC 203 and rejected (trajectory in which the ball 204 does not go through the goal ring) is recalculated.

Next, in step S103, the processor 81 causes the shooting motion of the PC 201 (which is continued even after a shot) to continue. This process is continued until the PC 201 lands after the shot.

Next, in step S104 in FIG. 31, the processor 81 determines whether or not the ball 204 has passed through the goal ring. When the result of the determination is that the ball 204 has passed through the goal ring (YES in step S104), the processor 81, in step S105, adds points according to the shooting position information 322 to the user-side team. Next, in step S106, the processor 81 sets the end flag 319 to ON. Subsequently, in step S107, the processor 81 sets “successful shot” in the end state data 320. Thereafter, the shooting process is ended.

On the other hand, when the determination result in step S104 is that the ball 204 has not passed through the goal ring (NO in step S104), the processor 81 determines in step S113 whether or not the ball 204 not having passed through the goal ring, i.e., the shot having failed, is ascertained. For example, when the ball 204 has landed without passing through the goal ring, it is determined that the shot has failed. The determination result ascertains that the shot has failed (YES in step S113), and the processor 81 sets the end flag 319 to ON in step S114. Subsequently, in step S115, the processor 81 sets “failed shot” in the end state data 320. Thereafter, the shooting process is ended. On the other hand, if failure of the shot has not yet been ascertained (NO in step S113), the processes in steps S114 and S115 are skipped to end the shooting process.

Referring back to FIG. 27, when the shooting preparation process, the mid-jump process, or the shooting process has ended, the shooting mode process is ended.

Referring back to FIG. 24, subsequently to the moving state process, the stop state process, or the shooting mode process, the processor 81, in step S7, transmits data including various kinds of operation information and the like (corresponding to the other apparatus data 321) to the other game systems 1. For example, when the shooting operation has been performed, information indicating this is transmitted to the other game systems 1.

Next, in step S8, the processor 81 generates a game image in which the results of the above-described various kinds of game processing are reflected, and outputs the game image.

Next, in step S9, the processor 81 determines whether or not the end flag 319 is ON. If the end flag 319 is not ON (NO in step S9), the processor 81 returns to step S1, and the processes are repeated. In the end flag 319 is ON (YES in step S9), the processor 81 displays, in step S10, a representation for successful shot or a representation for failed shot, based on the end state data 320. This is the end of (one set of) game processing.

As described above, in the exemplary embodiment, the controller is vibrated when the shooting operation is performed. Thereafter, when the period corresponding to the communication delay time has elapsed, control to start the shooting motion and movement of the ball 204 is performed. Therefore, even in the case of delaying the action start timing of the character with respect to the operation timing taking the communication delay into consideration, the feedback due to the vibration is outputted without a delay, whereby an impression that start of the shooting motion is delayed with respect to the shooting operation is weakened, and the bodily sensation of the user is improved.

### Modifications

In the exemplary embodiment described above, vibration is outputted in processing a frame in which a shooting operation is detected. In this regard, detection of the shooting operation and output of the vibration may not necessarily be performed at the same timing in terms of frame unit. For example, vibration may be outputted in processing a frame one frame after detection of the shooting operation. That is, as long as the user feels that detection of the shooting operation and output of the vibration are performed at the same timing, the timings thereof may not necessarily be made to accurately coincide with each other.

In another embodiment, the shooting sound effect may be outputted at the output timing of vibration as described above. In this case, since two types of feedbacks, i.e., vibration and shooting sound effect, can be obtained at the timing of the shooting operation, the bodily sensation of the user regarding the shooting operation can be further improved. Furthermore, in still another embodiment, the shooting sound effect may be outputted at a timing that is later than vibration output and earlier than start of shooting motion.

Regarding the shooting motion start timing in consideration of the communication delay, a limit may be imposed on a period to be delayed. For example, control may be performed such that, regardless of the delay time, the shooting motion is started after 8 frames at most from when the shooting operation is detected.

Controlling output of vibration as described above is applicable to general games in which it is effective to delay start of a certain action (shooting motion in the above embodiment) that the PC 201 performs in response to a shooting operation (controller swing operation) as described above in view of communication delay. For example, vibration control as described above is useful in performing a process of throwing a ball by a controller swing operation in a communication match dodgeball game.

In the exemplary embodiment, the game processing as described above is executed by a single main body apparatus 2. The main body apparatus 2 may include a plurality of storages and a plurality of processors. The above game processing may be shared and executed by these storages and processors. In addition, the above-described processing may be executed in a distributed system including a plurality of information processing apparatuses including a server.

While the present disclosure has been described in detail, the foregoing description is in all aspects illustrative and not restrictive. It is to be understood that numerous other modifications and variations can be devised without departing from the scope of the present disclosure.

What is claimed is:

1. A non-transitory computer-readable storage medium having stored therein a game program causing a computer of an information processing apparatus to:
perform, in a virtual space, a multiplayer game in which a player character is controlled based on an operation input to an operation device, and an opponent character is controlled based on data acquired through communication with another information processing apparatus; and
in the multiplayer game,
specify a delay time of the communication, and
when a first determination condition based on the operation input has been satisfied,
output a signal for vibrating a vibration device included in the operation device, regardless of the delay time, and
cause the player character to start a first action when a period according to a length of the delay time has elapsed.

2. The non-transitory computer-readable storage medium having stored therein the game program according to claim 1, wherein
the operation device includes an inertial sensor,
the operation input includes at least inertial data based on an output of the inertial sensor, and
the first determination condition is a condition related to the inertial data.

3. The non-transitory computer-readable storage medium having stored therein the game program according to claim 1, further causing the computer to output a sound associated with the first action, when the first action is started.

4. The non-transitory computer-readable storage medium having stored therein the game program according to claim 1, further causing the computer to output the signal for vibrating the vibration device, and output a sound associated with the first action.

5. The non-transitory computer-readable storage medium having stored therein the game program according to claim 1, wherein
the multiplayer game is a ball sport game, and
the first action is an action of shooting a ball toward a goal.

6. The non-transitory computer-readable storage medium having stored therein the game program according to claim 5, further causing the computer to make the player character perform a block action of blocking a shot attempted by the opponent character, when a second determination condition based on the operation input has been satisfied.

7. A game system including a computer,
the computer:
performing, in a virtual space, a multiplayer game in which a player character is controlled based on an operation input to an operation device, and an opponent character is controlled based on data acquired through communication with another information processing apparatus; and
in the multiplayer game,
specifying a delay time of the communication, and
when a first determination condition based on the operation input has been satisfied,
outputting a signal for vibrating a vibration device included in the operation device, regardless of the delay time, and
causing the player character to start a first action when a period according to a length of the delay time has elapsed.

8. The game system according to claim 7, wherein
the operation device includes an inertial sensor,
the operation input includes at least inertial data based on an output of the inertial sensor, and
the first determination condition is a condition related to the inertial data.

9. The game system according to claim 7, wherein
the computer further outputs a sound associated with the first action, when the first action is started.

10. The game system according to claim 7, wherein
the computer further outputs the signal for vibrating the vibration device, and outputs a sound associated with the first action.

11. The game system according to claim 7, wherein
the multiplayer game is a ball sport game, and
the first action is an action of shooting a ball toward a goal.

12. The game system according to claim 11, wherein
the computer further makes the player character perform a block action of blocking a shot attempted by the opponent character, when a second determination condition based on the operation input has been satisfied.

13. A game processing method for causing a computer of an information processing apparatus to:
perform, in a virtual space, a multiplayer game in which a player character is controlled based on an operation input to an operation device, and an opponent character is controlled based on data acquired through communication with another information processing apparatus; and
in the multiplayer game,
specify a delay time of the communication, and
when a first determination condition based on the operation input has been satisfied,
output a signal for vibrating a vibration device included in the operation device, regardless of the delay time, and
cause the player character to start a first action when a period according to a length of the delay time has elapsed.

14. The game processing method according to claim 13, wherein
the operation device includes an inertial sensor,
the operation input includes at least inertial data based on an output of the inertial sensor, and
the first determination condition is a condition related to the inertial data.

15. The game processing method according to claim 13, further causing the computer to output a sound associated with the first action, when the first action is started.

16. The game processing method according to claim 13, further causing the computer to output the signal for vibrating the vibration device, and output a sound associated with the first action.

17. The game processing method according to claim 13, wherein
the multiplayer game is a ball sport game, and
the first action is an action of shooting a ball toward a goal.

18. The game processing method according to claim 17, further causing the computer to make the player character perform a block action of blocking a shot attempted by the opponent character, when a second determination condition based on the operation input has been satisfied.
